(19) United States
(12) Patent Application Publication
(10) Pub. No.: US 2020/0408619 A1
(43) Pub. Date: Dec. 31, 2020

(54) MECHANICAL-STRESS SENSOR AND MANUFACTURING METHOD

(71) Applicant: ELTEK S.p.A., Casale Monferrato (Alessandria) (IT)

(72) Inventors: Marco PIZZI, Casale Monferrato (Alessandria) (IT); Stefano ALLERA, Casale Monferrato (Alessandria) (IT)

(21) Appl. No.: 16/978,169

(22) PCT Filed: Mar. 6, 2019
(86) PCT No.: PCT/IB2019/051805

§ 371 Date: Sep. 3, 2020

(30) Foreign Application Priority Data
Mar. 8, 2018 (IT) 102018000003387

(51) Int. Cl. G01L 1/16; G01L 5/167

(52) U.S. Cl. CPC G01L 1/162; G01L 5/167

(57) ABSTRACT

A mechanical-stress sensor comprises a piezoelectric transducer (10), which is able to generate an electrical signal representing a shear stress. The piezoelectric transducer (10) comprises: a layer of piezoelectric material (11), which extends in a longitudinal direction and has a polarization axis (A), which extends in a direction transverse to the longitudinal direction; and at least one first electrode (E1) and one second electrode (E2), each having a plurality of fingers (F1, F2), which extend at a first major face and a second major face, respectively, of the layer of piezoelectric material (11). The piezoelectric transducer (10) comprises at least one third electrode (E3) and one fourth electrode (E4), each having a plurality of fingers (F3, F4), which extend at the first major face and second h major face, respectively, of the layer of piezoelectric material (11), the fingers (F3) of the third electrode (E3) being interdigitated or alternating with the fingers (F1) of the first electrode (E1), and the fingers (F4) of the fourth electrode (E4) being interdigitated or alternating with the fingers (F2) of the second electrode (E2).

### FIELD OF THE INVENTION

The present invention relates to mechanical-stress sensors and has been developed with particular reference to stress sensors of a piezoelectric type and to the modalities for manufacture thereof.

### PRIOR ART

The use of piezoelectric stress sensors is widely known for detecting transverse (shear) stresses or normal or axial (compressive) stresses. Such sensors are, for example, used for providing acceleration sensors, pressure sensors, vibration sensors, deformation sensors, and so forth. Also the specific applications and the industrial sectors of use of the sensors referred to are extremely varied, and include the vehicle sector (e.g., for providing impact sensors or sensors for detecting engine knock), the consumer-electronics sector (e.g., for providing touch input devices or devices for measuring consumption of ink by printer cartridges), the medical sector (e.g., for providing of cardiovascular sensors), the building sector (e.g., for providing stress sensors for concrete structures), and so forth.

Notwithstanding their wide diffusion, some piezoelectric sensors, in particular those for detecting shear stresses, still present some drawbacks, which are linked, for example, to their manufacturing modalities.

### AIM AND SUMMARY OF THE INVENTION

In its general terms, the present invention has basically the aim to provide a mechanical-stress sensor of a piezoelectric type, that is simple and inexpensive to manufacture, but distinguished by a high reliability of operation. This and other aims still, which will emerge more clearly hereinafter, are achieved, according to the present invention, by a mechanical-stress sensor and by a corresponding manufacturing method that present the characteristics referred to in the annexed claims. The claims form an integral part of the technical teaching provided herein in relation to the invention.

### BRIEF DESCRIPTION OF THE DRAWINGS

Further aims, characteristics, and advantages of the invention will emerge clearly from the ensuing detailed description, with reference to the annexed drawings, which are provided purely by way of explanatory and non-limiting example and in which:

FIG. 1 is a schematic perspective view of a stress sensor according to first possible embodiments of the invention;

FIG. 2 is an exploded schematic view of a stress sensor according to first possible embodiments of the invention;

FIGS. 3 and 4 are schematic representations in plan view and from beneath, respectively, of a piezoelectric transducer of a stress sensor according to first possible embodiments of the invention;

FIG. 5 is a schematic perspective view of a first portion of a stress sensor according to first possible embodiments of the invention;

FIG. 6 is a schematic perspective view of a second portion of a stress sensor according to first possible embodiments of the invention;

FIG. 7 is a first sectioned perspective view of the portion of sensor of FIG. 6;

FIG. 8 is a detail at a larger scale of the portion of sensor of FIG. 7;

FIG. 9 is a second sectioned perspective view of the portion of sensor of FIG. 6;

FIG. 10 is a detail at a larger scale portion of sensor of FIG. 9;

FIGS. 11 and 12 are schematic representations in front elevation of a piezoelectric transducer of a stress sensor according to first possible embodiments of the invention, in two different configurations of electrical connection;

FIG. 13 is a schematic perspective view aimed at exemplifying an operating principle of a piezoelectric transducer of a stress sensor according to first possible embodiments of the invention;

FIGS. 14, 15, 16, 17, 18, 19, 20, 21, and 22 are views similar to those of FIGS. 1, 2, 6, 7, 8, 9, 10, 11, and 12, respectively, that represent a stress sensor according to second possible embodiments of the invention;

FIG. 23 is a view similar to that of FIG. 22, aimed at exemplifying an operating principle of a piezoelectric transducer of a stress sensor according to second possible embodiments of the invention;

FIGS. 24, 25, 26, 27, 28, 29, 30, 31, and 32 are views similar to those of FIGS. 14, 15, 17, 18, 19, 20, 21, 22, and 23, respectively, that represent a stress sensor according to third possible embodiments of the invention;

FIGS. 33, 34, and 35 are views similar to those of FIGS. 1, 2, and 6, respectively, that represent a stress sensor according to fourth possible embodiments of the invention;

FIG. 36 is a detail at a larger scale of the representation of FIG. 35;

FIG. 37 is a sectioned view of a part of FIG. 35;

FIG. 38 is a partially sectioned schematic perspective view of a portion of a substrate of a piezoelectric transducer of a stress sensor according to fourth possible embodiments of the invention;

FIG. 39 is a detail at a larger scale of the representation of FIG. 38;

FIGS. 40 and 41 are views similar to those of FIGS. 7 and 8 that represent a stress sensor according to fourth possible embodiments of the invention;

FIGS. 42, 43, and 44 are views similar to those of FIGS. 21, 22, and 23 that represent a stress sensor according to fourth possible embodiments of the invention;

FIGS. 45, 46, and 47 are a schematic perspective view, a front elevation, and a side elevation, respectively, of a sensor device integrating a stress sensor according to possible embodiments of the invention;

FIGS. 48 and 49 are exploded schematic views, from different angles, of a sensor device integrating a stress sensor according to possible embodiments of the invention;

FIGS. 50 and 51 are sectioned schematic perspective views of a sensor device integrating a stress sensor according to possible embodiments of the invention; and

FIG. 52 is a schematic view similar to that of FIG. 3 that represents a possible variant embodiment.

### DETAILED DESCRIPTION OF PREFERRED EMBODIMENTS OF THE INVENTION

Reference to “an embodiment”, “one embodiment”, “various embodiments”, and the like, in the framework of the present description is intended to indicate that at least one particular configuration, structure, or characteristic described in relation to an embodiment is comprised in at least one embodiment. Hence, phrases such as “in an embodiment”, “in one embodiment”, “in various embodiments”, and the like that may be present in various points of this description do not necessarily refer to one and the same embodiment, but may, instead, refer to different embodiments. Moreover, particular conformations, structures, or characteristics defined in the framework of the present description may be combined in any adequate way in one or more embodiments, which may even be different from the ones shown. The reference numbers and spatial references (such as “top”, “bottom”, “up”, “down”, “front”, “back”, “vertical”, etc.) provided herein, in particular with reference to the examples in the figures, are merely used for convenience and hence do not define the sphere of protection or the scope of the embodiments. In the present description and in the attached claims, the generic term “material” is to be understood as including also mixtures, compositions, or combinations of a number of different materials. In the figures, the same reference numbers are used to designate elements that are similar or technically equivalent to one another.

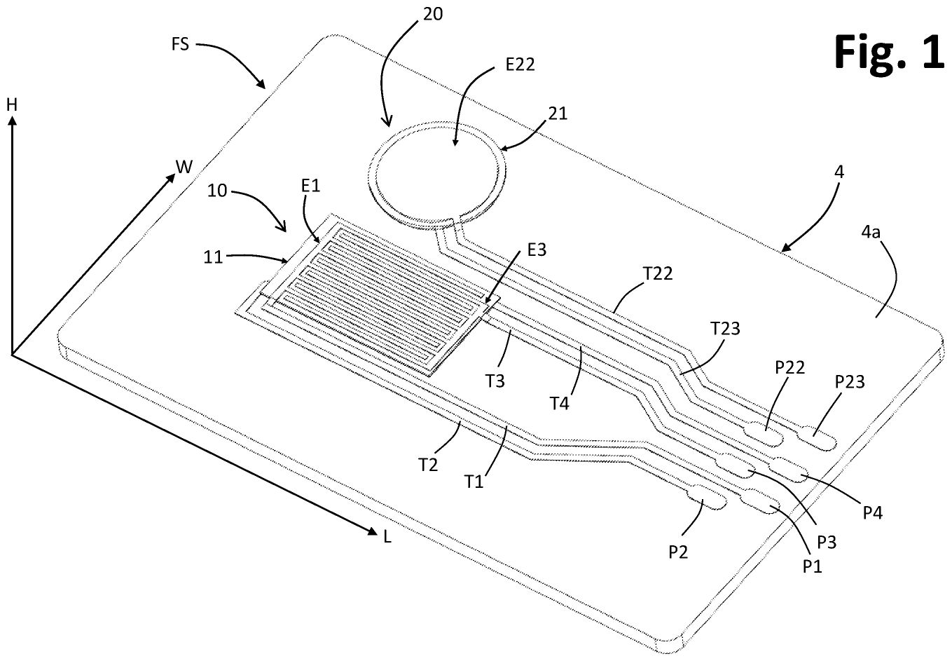

With initial reference to FIG. 1, designated as a whole by FS is a mechanical-stress sensor according to possible embodiments of the invention. The sensor FS has a supporting structure, for example designed to be secured in a stationary position, and associated to the supporting structure is at least one piezoelectric transducer, as described hereinafter. In various embodiments, the supporting structure comprises a support or substrate 4, preferably but not necessarily of a substantially planar shape, having a length, a width, and a thickness that extend in the directions denoted by L, W, and H, respectively, in FIG. 1. These directions L, W, and H will also be referred to hereinafter as longitudinal direction, transverse direction, and axial direction, respectively, with reference to the plane of the substrate 4.

The substrate 4 may be made of electrically insulating material or electrically conductive material coated at least in part with an electrically insulating material; for example, it may be made of metal or a metal alloy (e.g., steel) coated with a layer of dielectric material (e.g., a polymer or a metal oxide or mixtures of oxides), or else it may be made of a ceramic material or a ceramic oxide or mixtures of ceramic oxides (e.g., alumina or mixtures of alumina and zirconia), or else again of a semiconductor material (e.g., silicon) or a material comprising silicon oxides or silica (e.g., glass) or polymers or mixtures of materials comprising at least one polymer (in the case where the substrate is a polymeric substrate or comprises a polymer and the transducer is obtained by deposition of successive layers, it will be preferable to use also a polymeric piezoelectric material, such as PVDF, for reasons of compatibility of process temperatures). Not, however, excluded from the scope of the invention is the use of other materials suitable for the purpose or other materials according to the known technique. Provided at a major face 4a of the substrate 4 (here conventionally defined also as “upper face”) is at least one first piezoelectric transducer, designated as a whole by 10, in particular configured for detecting shear stresses, i.e., stresses due to forces that have at least one component in the longitudinal direction L and/or in the transverse direction W. In various embodiments, the transducer 10 is designed to be associated mechanically to an element, a displacement or a deformation of which is to be detected, and is able to generate an electrical signal representing a shear stress determined by such a displacement or deformation.

In various embodiments, preferably at the same face 4a of the substrate 4, at least one further transducer may be provided, designated as a whole by 20, which is preferably also of a piezoelectric type, in particular configured for detecting normal stresses, i.e., stresses due to forces that have at least one component in the axial direction H.

As has been mentioned, and as will emerge more clearly hereinafter, in various embodiments, to the upper part of the transducer 10, i.e., its part opposite to the substrate 4, there is to be associated or connected mechanically a generic body or element hereinafter defined for simplicity also as “detected element” that is able to perform movements or undergo deformations relative to the supporting structure, here represented by the substrate 4. In other words, on the aforesaid detected element there can be applied a force having at least one component in the directions L and/or W, of which it is desired to measure the intensity through the transducer 10. The detected element may, for example, be a seismic mass, when the sensor FS is used in an accelerometer, or any generic object or entity of which it is desired to detect a possible albeit minimal displacement or vibration or deformation, and hence forces that act on the aforesaid object or entity.

Given that the lower part of the transducer 10 is in a fixed position relative to the substrate 4 (which in turn is assumed to be in a stationary position), and the upper part of the transducer 10 is associated or fixed (e.g., glued) to the aforesaid detected element, a force applied to the latter in the direction W and/or in the direction L causes a stress on the transducer 10, which—by the piezoelectric effect—generates across corresponding electrodes a potential difference proportional to the intensity of the shear stress applied.

The same detected element can be associated also to the upper part of the other piezoelectric transducer 20, when an axial force having at least one component could be applied to the detected element in the direction H. This axial force hence causes a corresponding stress on the transducer 20, which, by the piezoelectric effect, generates across corresponding electrodes a potential difference, which represents the intensity of the normal stress applied.

Of course, there can be associated to the transducer 20 a second detected element, different from the one that is associated to the transducer 10. It is likewise clear that the aforesaid detected element does not necessarily have to be fixed to the transducer 20, but may simply be set on top of it. On the other hand, it is not even strictly necessary for the detected element to be fixed to the transducer 10 if the two parts in question are in any case set resting on top of one another or adherent or constrained to one another, or in any case associated in such a way as to guarantee that a movement or a deformation of the detected element in the direction L and/or in the direction W determines a corresponding stress on the transducer 10.

In various embodiments, the transducer 10, or each transducer 10, 20, comprises at least one element or layer of piezoelectric material (hereinafter, referred to for simplicity as “piezoelectric layer”) and at least two electrodes, each of which is associated to a major face of the piezoelectric layer. Preferably, the electrodes are defined by tracks of electrically conductive material (hereinafter referred to for simplicity as “conductive tracks”), with these tracks that may possibly define—at their end opposite to the corresponding electrode—terminal connection portions, for example in the form of pads. With reference, for example, to FIG. 1, where the piezoelectric layers of the transducer 10 and of the transducer 20 are designated by 11 and 21, respectively, the letters T, E, and P (followed by corresponding reference numbers) identify the aforesaid conductive tracks, some of the corresponding electrodes, and the corresponding terminal portions or pads, respectively. It should be noted that the electrodes E and the tracks T do not necessarily have to be formed integrally: for example, it is possible to form the piezoelectric layer 11 or 21 as a stand-alone body, in the form of a plate or lamina, then form the electrodes E on the opposite major faces of the corresponding piezoelectric layer 11 or 21, then form the tracks T with the corresponding pads P on the upper face 4a of the substrate 4, and finally secure the layer 11 or 21 carrying the electrodes E on the face 4a of the substrate 4, providing the necessary connections between the electrodes E and the corresponding tracks T.

Preferably, the piezoelectric layer 11 and/or 21, the tracks T and the electrodes E are substantially planar and lie substantially parallel to one another and to the surface of the upper face 4a of the substrate 4.

In various embodiments, the transducer 10 and/or 20, i.e., the piezoelectric layer 11 and/or 21, is formed via deposition of material on the substrate 4 and/or at least in part on the lower electrodes, for example via screen printing or spin coating.

Preferably, also the electrodes E, or the conductive tracks T, are formed using deposition processes, for example employing screen-printing techniques, or sputtering techniques, or techniques of thermal evaporation, or dispensing techniques or, more in general, any known technique designed for deposition of electrically conductive materials on a corresponding substrate.

The electrodes E and/or the conductive tracks T with the corresponding pads P could, however, be formed at least in part as distinct elements, for example electrically conductive metal elements, preferably shaped or blanked from sheet metal, and designed then to be fixed to the respective piezoelectric layer 11 and/or 21, and/or to the substrate 4.

In various preferential embodiments, the entire transducer 10 and/or 20 is obtained via deposition of successive layers of different materials on the substrate 4, i.e., by first depositing the electrically conductive parts that are to be at least in part at the lower face of the layer 11 and/or 21, then depositing the piezoelectric layer 11 and/or 21, and finally depositing the electrically conductive parts that are to be at least in part at the upper face of the layer 11 and/or 21.

Deposition in stacked layers may be made, for example, using screen-printing techniques, in which case the piezoelectric layer 11 and/or 21 may have a thickness of between 20 and 300 μm, preferably approximately 100 μm, with the electrodes E and the tracks T having, instead, a thickness of between 8 and 25 μm, preferably approximately 15 μm. Alternatively, the piezoelectric layer (and the electrodes E and/or the tracks T) may be deposited using thin-film techniques (such as sol gel, sputtering, or chemical vapour deposition), in which case the layer may have a thickness comprised between 50 and 2000 nm, preferably between 500 and 800 nm (the tracks/electrodes may have a thickness comprised between 50 and 200 nm, preferably between 80 and 120 nm, and may be deposited by sputtering, thermal evaporation, or screen printing with organometal inks).

The layer 11, or each layer 11 and/or 21, can be deposited using piezoceramic-based paste, whereas the electrodes E can be obtained with paste with a base of metals, preferably noble metals (e.g., a platinum-based paste, or a silver-based paste, or a silver-palladium-based paste, or a silver-platinum-based paste).

The piezoelectric layer 11, or each piezoelectric layer 11 and/or 21, may be obtained also with techniques other than the ones exemplified above and/or not necessarily via deposition or growth of material on a substrate: for example, a piezoelectric layer could be configured as a body made of piezoceramics obtained by compression of powders and subsequent sintering thereof, on the two major faces of which the electrodes E are subsequently deposited or applied, and then connected to the corresponding tracks T, which are provided, instead, on the upper face 4a of the substrate 4.

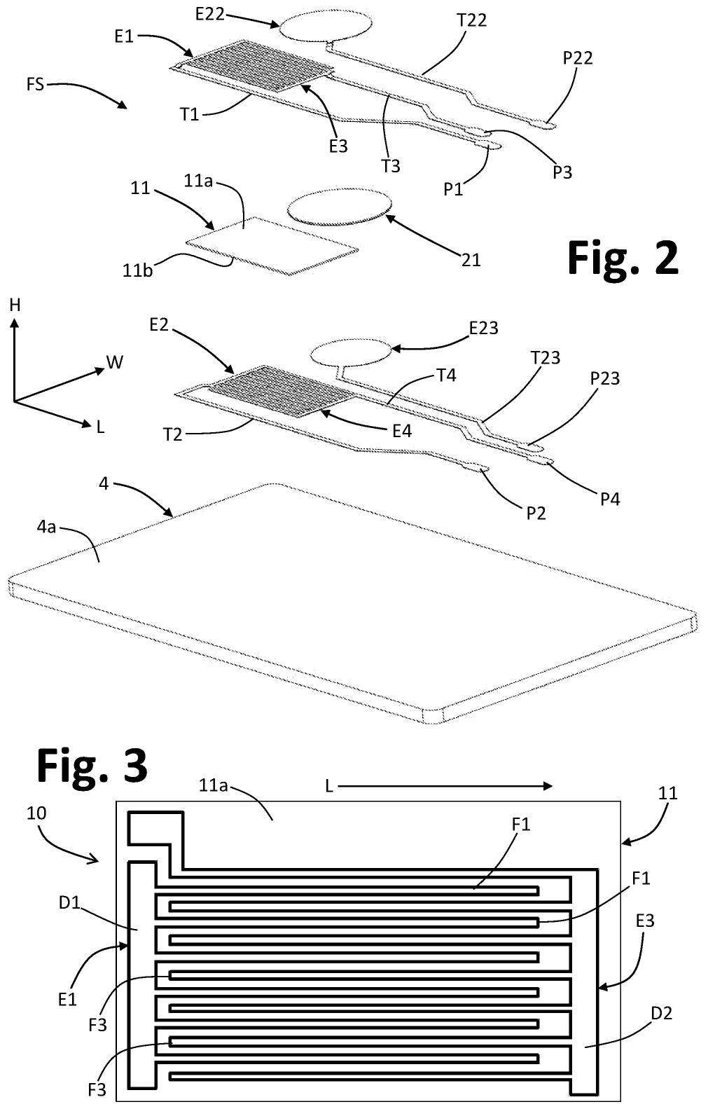

In FIG. 2, the sensor SF is represented schematically in exploded view. As may be noted, in various embodiments, the piezoelectric layer 11 extends in the longitudinal direction L and has two opposite major faces 11a and 11b, located at which are a first electrode E1 and a second electrode E2, respectively. Preferably associated to each electrode E1 and E2 is a corresponding conductive track T1 and T2, deposited or in any case obtained at least in part on the face 4a of the substrate 4, which defines a respective connection pad P1 and P2. In the example, the piezoelectric layer 21 of the second transducer has a circular shape, and associated to its opposite major faces (not shown) are respective electrodes E22 and E23, which are also preferably circular. Also associated to each electrode E22 and E23 is a corresponding conductive track T22 and T23, obtained at least in part on the face 4a of the substrate 4, which defines a respective connection pad P22 and P23. It should be noted that the circular shape of the piezoelectric layer 21 and of the corresponding electrodes E22, E23, however preferable, is not imperative.

As has been said, assuming a deposition in layers stacked on top of one another of the type exemplified above for both of the transducers 10 and 20 of FIG. 1, for example by screen printing, on the face 4a of the substrate 4 there are first deposited the tracks T2 and T23 that define the electrodes E1 and E23 with the corresponding pads P2 and P23, then on the face 4a of the substrate 4 and on the parts of the tracks T2 and T23 that define the electrodes E2 and E23 the piezoelectric layers 11 and 21 are deposited, and finally the tracks T1 and T22 are deposited, with a part thereof (comprising pads P1 and P22) that extends on the face 4a of the substrate 4, and with part thereof defining the electrodes E1 and E22 that extends, instead, on the upper faces of the piezoelectric layers 11 and 21, respectively.

As has been said, in any case, the electrodes E1, E2 and E22, E23 may be configured as distinct parts formed on the opposite major faces of the layers 11 and/or 21 previously obtained by sintering or in some other way, and may be then connected electrically during assembly of the transducers 10 and 20 on the substrate 4, on which the tracks T1, T2 and T22, T23 are instead obtained.

Irrespective of the mode of production, the electrodes E1 and E2 are preferably comb-like electrodes, i.e., electrodes each having at least a plurality of portions, or teeth, or fingers (referred to hereinafter simply as “fingers”), which extend at the two opposite major faces 11a and 11b, respectively, of the piezoelectric layer 11 in a direction of extension of the latter, here the longitudinal direction L.

According to one aspect of the invention, and with reference in particular to FIG. 2, the piezoelectric transducer 10 comprises at least one third electrode E3 and at least one fourth electrode E4, which are also comb-like electrodes, or in any case have a plurality of fingers that extend in the longitudinal direction L at the two opposite major faces 11a and 11b, respectively, of the piezoelectric layer 11. Once again according to the invention, the fingers of the third electrode E3 are interdigitated or alternating with the fingers of the first electrode E1, and the fingers of the fourth electrode E4 are interdigitated or alternating with the fingers F2 of the second electrode E2.

The electrodes E3 and E4 are preferably formed using the same technique as the one used to form the electrodes E1 and E2, and are obtained in the same production step. Consequently, with reference once again to the aforementioned example of deposition in stacked layers using the screen-printing technique, the track T4 with the electrode E4 will be formed in the same deposition step as that in which the track T2 with the electrode E2 is obtained on the substrate 4, whereas the track T3 with the electrode E3 will be formed in the same deposition step as that in which the track T1 with the electrode E1 is obtained in part on the piezoelectric layer 11 and in part on the substrate 4.

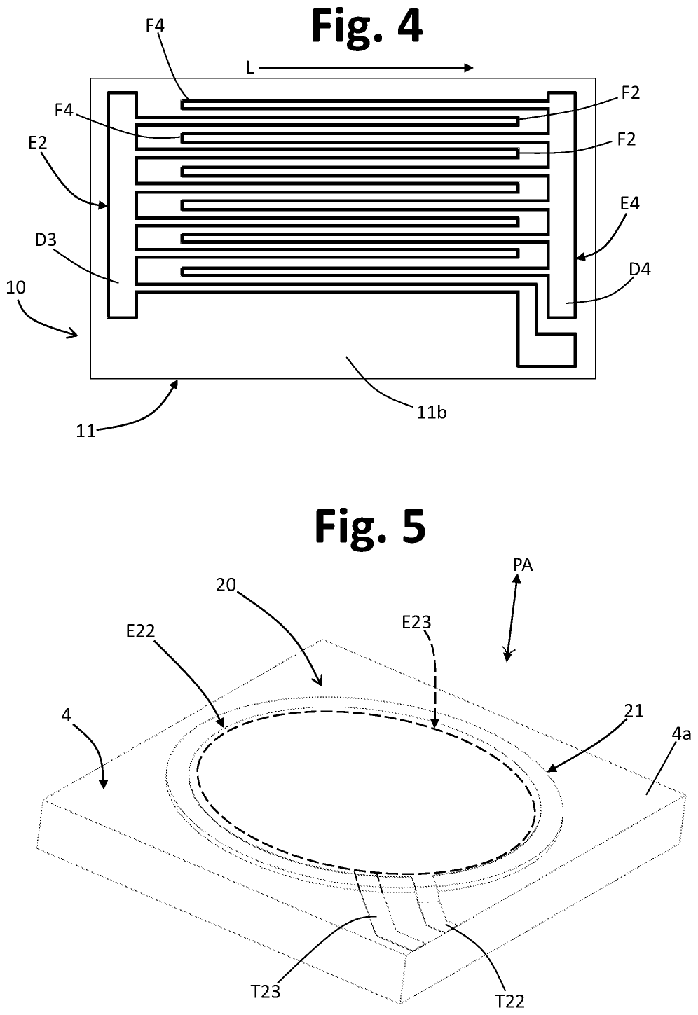

FIGS. 3 and 4 exemplify schematically possible geometries of the electrodes E1 and E3 at the upper face 11a of the layer 11, and of the electrodes E2 and E4 at the lower face 11b of the layer 11.

As may be appreciated, in the non-limiting example, the aforesaid electrodes E1-E4 are comb-like electrodes, and hence comprise a series of portions, or teeth, or fingers that preferably extend substantially parallel to one another, here in the longitudinal direction L of the layer 11, and/or are preferably equally spaced (i.e., they are at a substantially constant distance apart), starting from respective busbar or distribution portions.

With reference, for example, to FIGS. 3 and 4, the letters “D” and “F”, followed by the number identifying the corresponding electrode, refer precisely to the aforesaid distribution portions of the electrodes E, as well as to the corresponding fingers, respectively. As has been said, the fingers F of the electrodes E that are on one and the same face of the layer 11 are interdigitated. In the preferential configuration, the fingers F of each comb-like electrode E are substantially rectilinear, but this however preferable does not constitute an essential characteristic, it being possible for the fingers to have, for example, even a different development.

In the example, also the distribution portions D of two electrodes E that are on one and the same face of the layer 11 are substantially parallel to one another, but not even this characteristic is to be deemed essential.

Visible in FIG. 5 is the portion of the substrate 4 at which the transducer 20 is located, which, as has been said, comprises an upper electrode E22 and a lower electrode E23, set between which is the corresponding piezoelectric layer 21. Preferably, when the transducer 20 is obtained via deposition of successive layers on the substrate 4, it is preferable for the layer 21 to have perimetral dimensions (here the circumference) larger than those of the electrodes E22 and E23, which are preferably substantially the same as one another: the larger perimetral dimension of the layer 21 as compared to that of the electrodes E22 and E23 simplifies stacking of the various layers of material during the deposition process, for example via screen printing. The transducer 20 operates basically as pressure sensor; i.e., the layer 21 generates a voltage (or potential difference) when the layer 21 is compressed, i.e., when the upper electrode E22 is pushed towards the lower electrode E23.

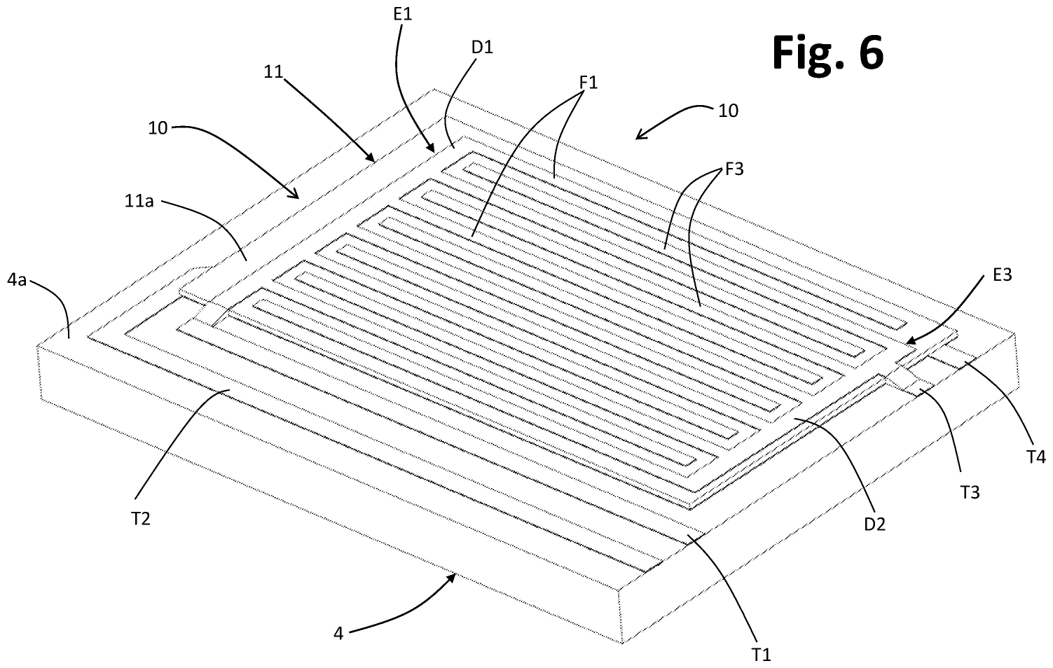

Visible, instead, in FIG. 6 is the portion of the substrate 4 at which the transducer 10 is located, which, as has been said, comprises the piezoelectric layer 11, with at least two lower comb-like electrodes (here not visible) in an interdigitated or alternating configuration, and at least two upper comb-like E1 and E3 in a interdigitated or alternating configuration. The area of the layer 11—which may, for example, be comprised between 1 and 600 mm², preferably between 2 and 100 mm²—is such as to cover the lower electrodes E2, E4, or at least the prevalent part of their fingers F2 and F4.

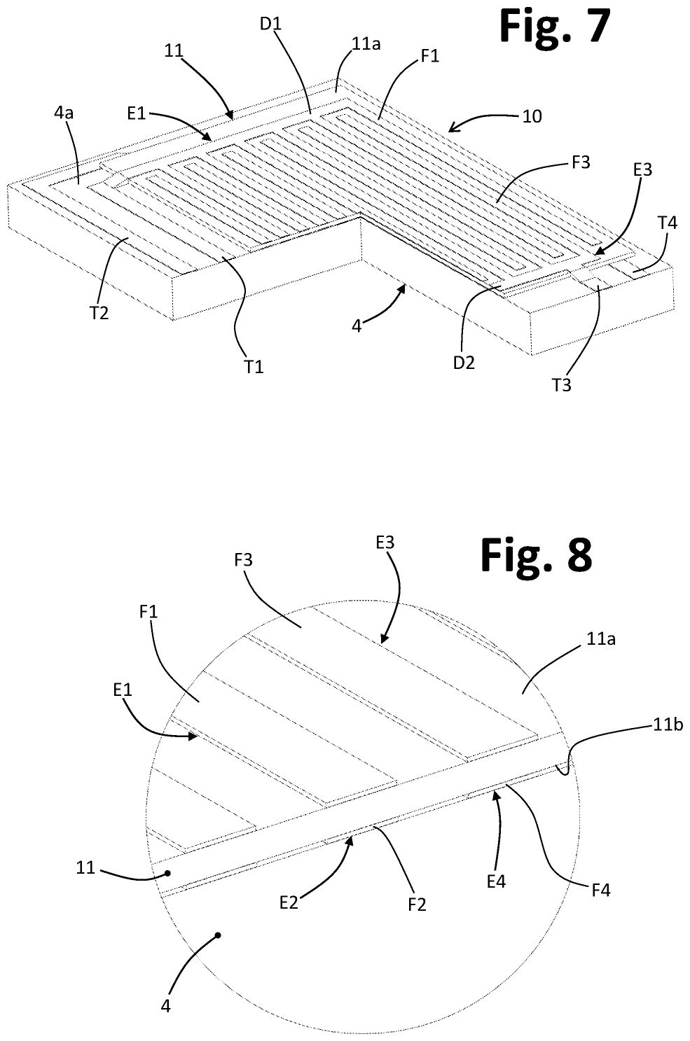

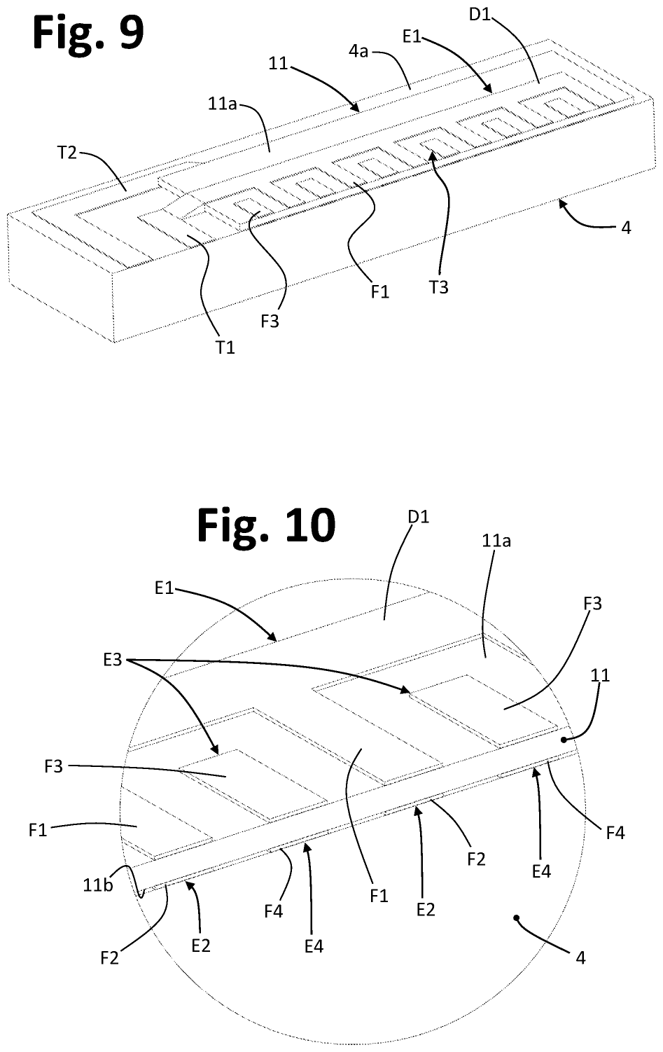

From the cross-sectional views of FIGS. 7-10, it may be noted how, in various embodiments, the fingers F of the various electrodes E are substantially symmetrical and in mutually facing or opposed positions. In particular, each finger F1 of the upper electrode E1 is in a position substantially overlying or aligned to a respective finger F2 of the lower electrode E2, and preferably has a shape and dimensions substantially equal to those of the latter. Likewise, each finger F3 of the upper electrode E3 is in a position substantially overlying or aligned to a respective finger F4 of the lower electrode E4, and preferably has a shape and dimensions substantially equal to those the latter.

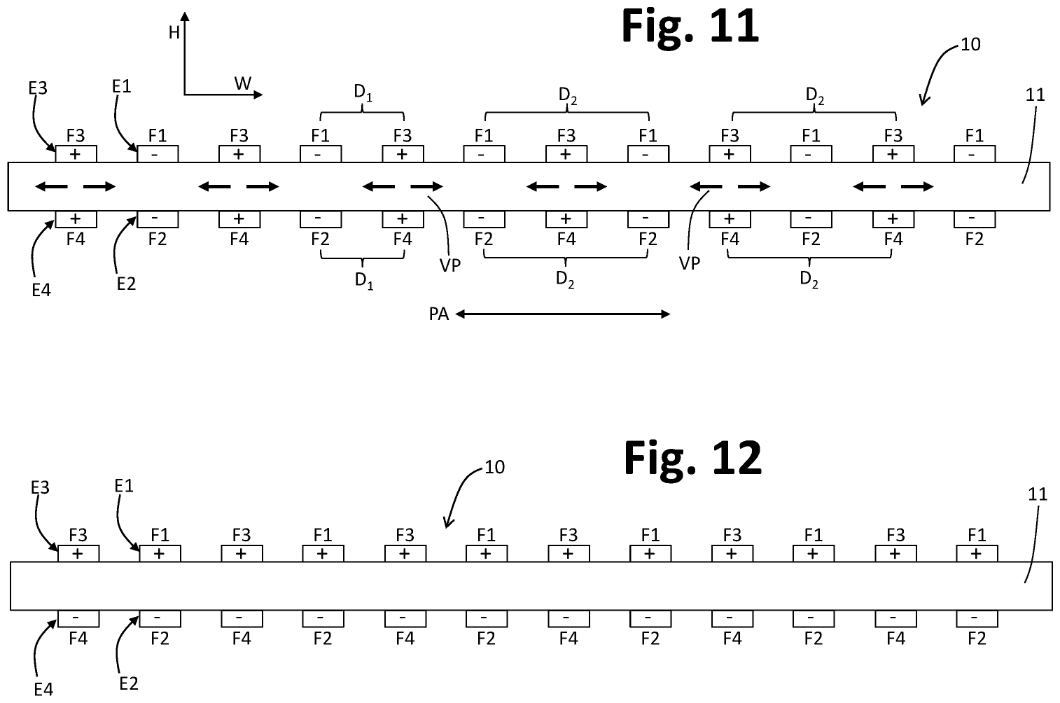

With reference, for example, to FIG. 11, in embodiments of this type, adjacent fingers F1 and F3 of the respective upper electrodes E1 and E3 extend substantially at a first distance D₁ from one another, whereas the distance D₂ between two consecutive fingers F1 of one and the same electrode E1, and likewise between two consecutive fingers F3 of one and the same electrode E3, is substantially not less than twice the first distance D₁, preferably substantially equal to twice the distance D₁. On the other hand, also adjacent fingers F2 and F4 of the respective lower electrodes E2 and E4 extend substantially at the aforesaid first distance D₁ from one another, and the distance D₂ between two consecutive fingers F2 of one and the same electrode E2, and likewise between two consecutive fingers F4 of one and the same electrode E4, is also substantially not less than twice the first distance D₁, preferably substantially equal to twice the distance D₁.

The piezoelectric layer 11 is preferably made of a ceramic material, such as a PZT (lead zirconate titanate), which must previously be subjected to a polarization process, in particular when it is necessary to obtain polarization of the piezoelectric material with an orientation different from that of subsequent mechanical excitation. For this purpose, between at least one of the lower electrodes E2 and E4, on the one hand, and at least one of the upper electrodes E1 and E3, on the other hand, there is applied an electrical field (indicatively comprised between 1 and 5 kV/mm), such as to orient the electrical dipoles internal to the layer 11 in a single direction (this operation being in general also known as “poling”). As may be noted, to carry out the polarization step, the transducer 10—i.e., the layer 11—is normally heated to a given temperature, for example comprised between 120° C. and 140° C., normally in any case lower than the Curie point, which is variable as a function of the piezoelectric material chosen (here, there may be assumed the case of a piezoceramic with a Curie point of approximately 350° C.). After this temperature is reached, the voltage is applied for a certain length of time, for example between 1 and 50 min, preferably between 10 and 20 min, this voltage being then maintained also during subsequent cooling of the material, as heating ceases.

It should be recalled that the piezoelectric effect (i.e., the capacity of a material to supply a potential difference when it is mechanically loaded, or else to undergo deformation if it is subjected to an electrical field) is essentially based upon distortions of its crystal lattice. A very common type of piezoceramic, such as PZT, is distinguished by a face-centred cubic lattice when it is at a temperature higher than the Curie point, where at the vertices of the faces there are atoms of metal (e.g., lead), at the centre of the faces there are oxygen atoms, and at the centre of the lattice there is an atom heavier than oxygen (e.g., titanium or zirconium). Below the Curie point the lattice is tetragonal or rhombohedral, as a function of the corresponding percentage of titanium and zirconium. Concentrations close to 50% are normally used, where both phases are simultaneously present. It could be advantageous to use compositions of PZT unbalanced in favour of titanium that have higher Curie points, for example with approximately 60% of titanium and 40% of zirconium. In the case where temperatures in the region of 200° C. are not exceeded, it is in any case advisable to remain in the proximity of the morphotropic boundary zones, which are comprised between 45% and 55% of relative concentration, preferably for a relative concentration of 52% titanium. It is moreover advantageous to use dopants, for example niobium, to improve the response of the piezoelectric sensors (preferred concentration lower than 1 wt %).

The heaviest central atom can assume an asymmetrical stable position, causing unbalancing in the charges, which results in the formation of an electrical dipole. Piezoelectric materials are hence biased by means of an intense electrical field, normally supported by heating, which orients the dipoles thereof as desired, and causes a collective polarization, which is stable in the limits of mechanical, thermal, or electrical stress of the material. At the end of the polarization process, the material is distorted in its lattice and reacts to mechanical or electrical stresses, with the same mechanism of displacement of mass and charge, and generating a variation of charge on its surfaces. If the material is not biased, the phenomenon occurs even so, but since the various domains are arranged randomly, the various effects cancel out.

Polarization is in the plane of the piezoelectric layer 11 with alternating directions between the polarization electrode at the positive potential (+) and the polarization electrode at the negative potential (−). It has recently been shown how the polarization step causes a migration of the oxygen vacancies towards the negative-potential polarization pole (see, for example, G. Holzlechner, et al., “Oxygen vacancy redistribution in PbZrxTil-xO3 (PZT) under the influence of an electric field”, in Solid State Ionics 262:625-629, 2014). It has moreover been shown how a higher concentration of oxygen vacancies causes a reduction in polarization of the piezoelectric ceramic (see, for example, A. B. Joshi, et al., “Effect of oxygen vacancies on crystallisation and piezoelectric performance of PZT”, in Ferroelectrics Vol. 494, 117-122, 2016).

In the specific case considered herein, there will hence be a higher quality of the piezoelectric material of the layer 11 in the proximity of the electrodes that, in the polarization step, have been set at the positive potential. By “quality of the material” is meant in this case a more orderly structure of the crystal lattice, due to a lower concentration of oxygen vacancies or, conversely, a higher concentration of oxygen ions that, in the ideal case, come to occupy all the oxygen sites available in the form of crystal, for example of the ABO₃ type, where in the most common case, which is that of PZT, corresponds to lead (Pb=A), zirconium or titanium (B=Zr or else B=Ti). Polarization of the material is hence more intense in the proximity of the electrodes connected to the positive potential, where the (negative) oxygen ions have migrated, leaving the (positive) oxygen vacancies in the proximity of the electrodes connected to the negative potential.

According to one aspect of the invention, polarization of the piezoelectric layer 11 is carried out with a configuration of electrical connection of the various upper and lower comb-like electrodes that is different from the configuration of electrical connection of the same electrodes that is subsequently adopted when the piezoelectric transducer 10 is used for detecting a shear stress.

In other words, the layer 11 is provided with electrodes that serve at least in part both for the purposes of polarization of the first layer of piezoelectric material and for the purposes of a subsequent measurement or detection of an electrical signal generated by the layer 11 itself.

FIG. 11 represents schematically for this purpose a possible step of polarization the transducer 10, namely, of the piezoelectric layer 11, where the electrodes E1 and E2 are electrically connected together to the negative potential (−), whereas the electrodes E3 and E4 are electrically connected together to the positive potential (+), and are electrically insulated from the electrodes E1 and E2. The oxygen ions will hence tend to concentrate in the proximity of the areas included between the fingers F3 and F4, in part in the area underlying the electrodes and in part in the area without electrodes, between the pairs of fingers F3-F4 and F1-F2 in the area closest to the fingers F3-F4, which is positively charged, whereas the oxygen vacancies will tend to concentrate in the proximity of the areas comprised between the fingers F1 and F2, in part in the area underlying the electrodes and in part in the area without electrodes, between the pairs of fingers F3-F4 and F1-F2 in the area closest to the fingers F1-F2, which is negatively charged.

In FIG. 11, the small arrows VP at the centre of the layer 11 represent the polarization vectors, determined by application of the potential difference between the electrodes E1 and E3, on the one hand, and the electrodes E2 and E4, on the other hand. As may be appreciated, the polarization axis, designated by PA, extends in the direction W, i.e., is transverse to the longitudinal direction L. The areas of the piezoelectric material that extend axially (direction H) between each pair of fingers F1-F2 and F3-F4 overlying one another are less polarized than the areas of the material that extend in a transverse direction (direction W) between the aforesaid pairs of fingers: this is basically due to the deformation of the polarized areas that are located between the aforesaid pairs of fingers, which tend to thin out and lengthen.

FIG. 12 illustrates, instead, how, in the subsequent use of the transducer 10 for the purposes of detection, the electrodes E1-E4 are exploited with a configuration of electrical connection that is different from the one used during polarization of the layer 11.

In particular, the upper electrodes E1 and E3 are electrically connected together (here, purely by way of example, to the positive potential +), whereas the lower electrodes E2 and E4 are electrically connected together (here, purely by way of example, to the negative potential −) and are electrically insulated from the other two electrodes E1 and E3. In this way, a shear stress applied to the piezoelectric layer 11 that has at least one component in the longitudinal direction L generates between the electrodes E1 and E3, on the one hand, and the electrodes E2 and E4, on the other hand, a potential difference, the value of which is substantially proportional to the shear stress applied.

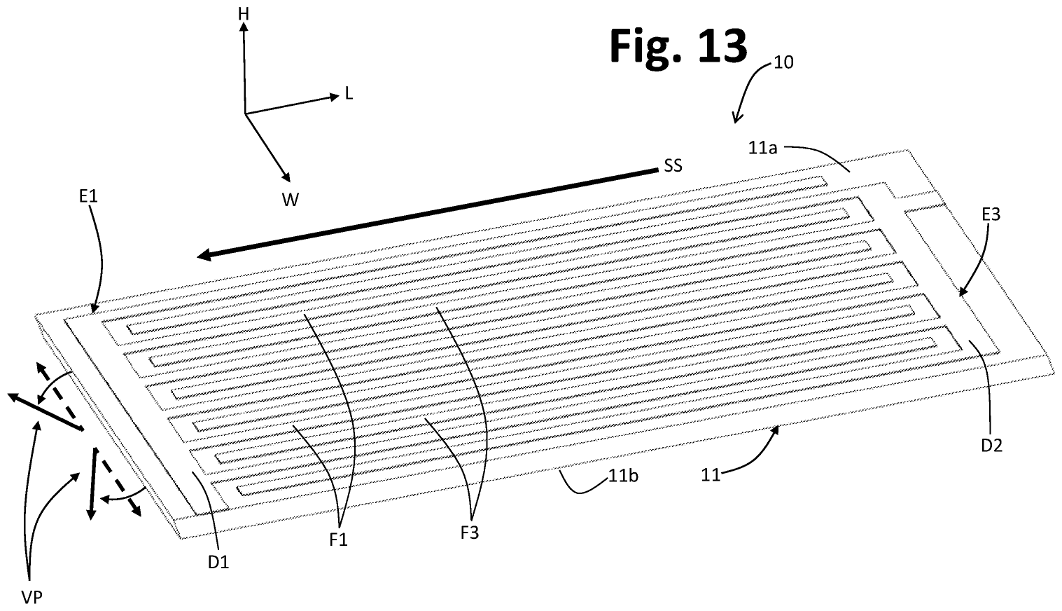

FIG. 13 is intended for this purpose to highlight schematically the behaviour of the polarization vectors VP, just two of which are represented schematically at a larger scale. When the layer 11 is subjected to a shear stress SS having at least one component in the direction of extension of the fingers F (here substantially in the longitudinal direction L), and hence in a direction substantially transverse or perpendicular to the polarization axis, an anisotropic rotation of the vectors VP is brought about, which causes onset of a charge between the upper electrodes E1 and E3 and the lower electrodes E3 and E4.

The embodiments described with reference to FIGS. 11-13—which are distinguished by a symmetrical arrangement between the fingers F1 and F3 of the upper electrodes E1 and E3 and the fingers F2 and F4 of the lower electrodes E2 and E4, with the fingers of the former substantially facing or overlying the fingers of the latter—enable detection of deformations of the layer 11 that occur (or have at least one component) in the longitudinal direction L. This type of operation is based upon the asymmetry of the polarization obtained on account of migration of the oxygen vacancies mentioned previously, but does not constitute an essential characteristic of the invention since, with different relative positionings between the fingers F and/or different configurations of electrical connection of the electrodes E during polarization and use, different modes of operation can be obtained.

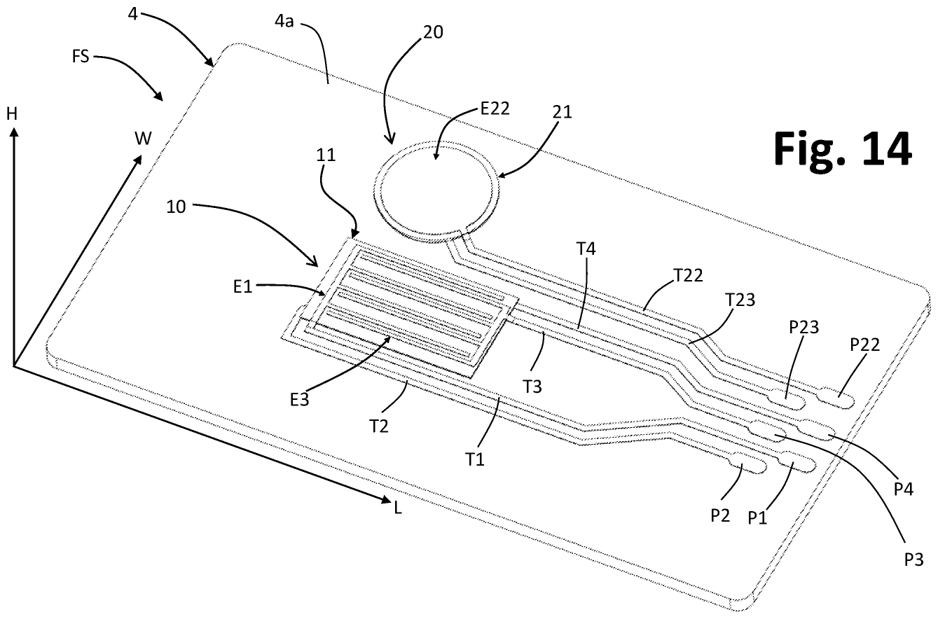

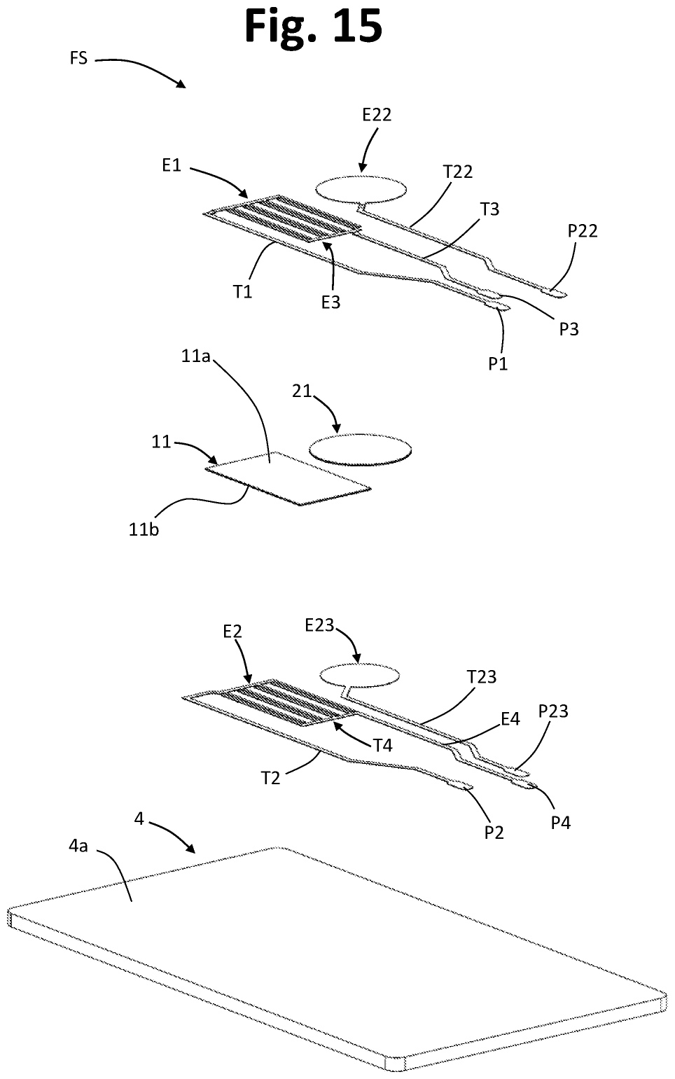

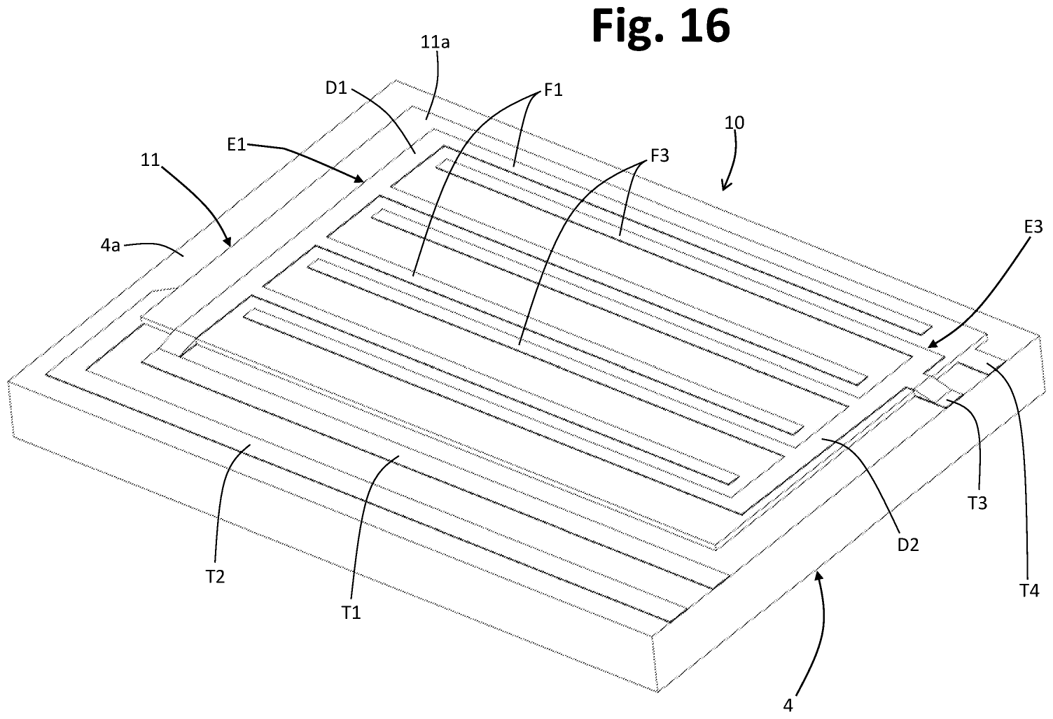

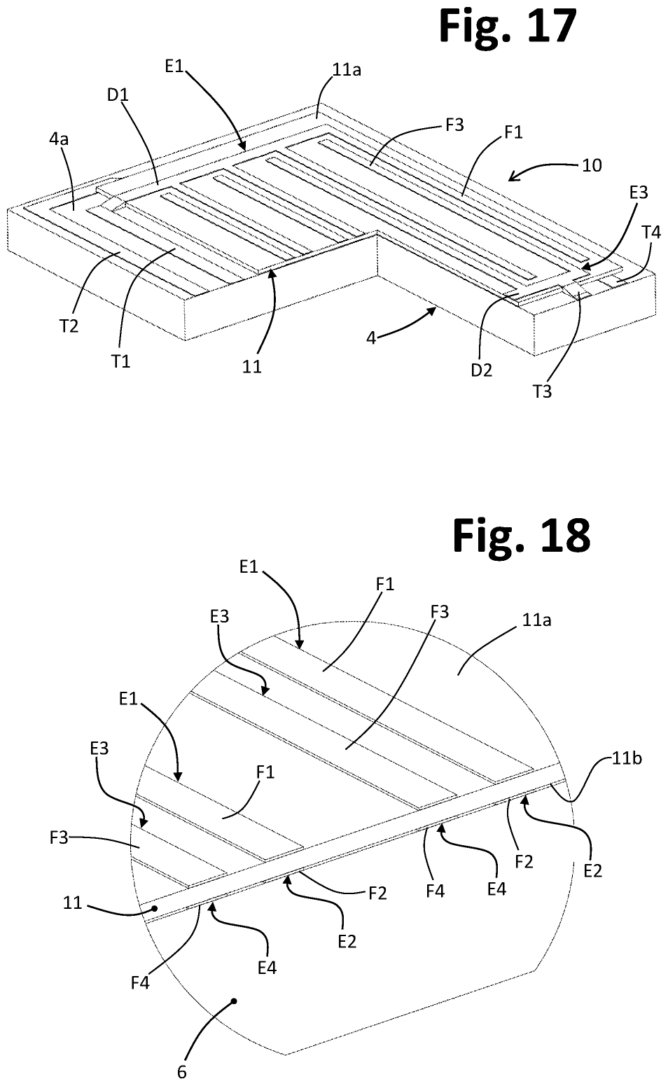

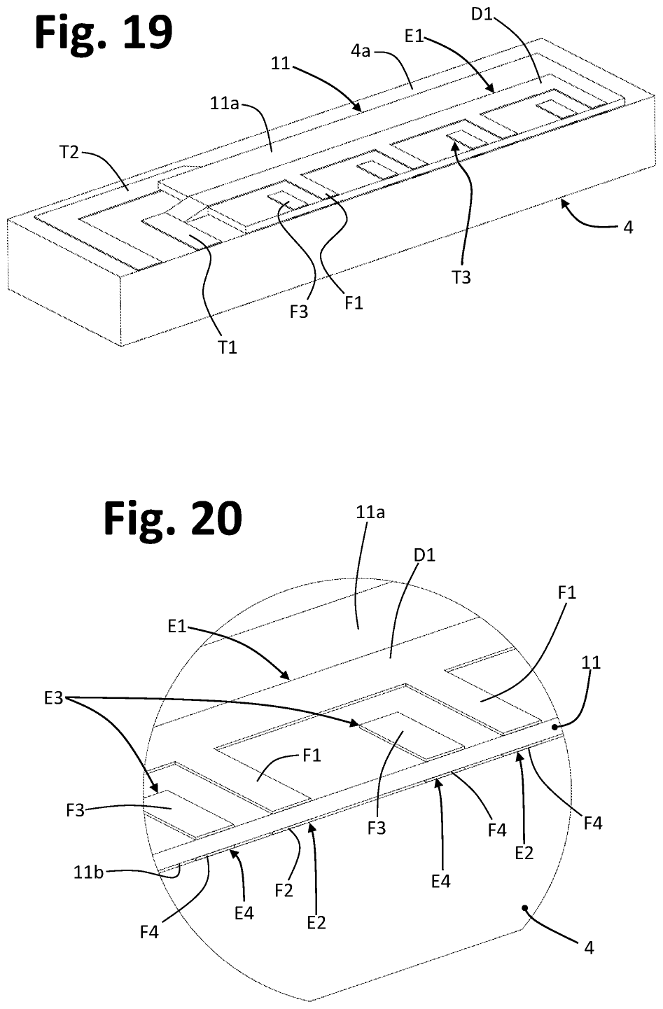

For instance, FIGS. 14-23 refer to embodiments distinguished by an asymmetrical arrangement between the upper electrodes E1, E3 and the lower electrodes E2, E4, namely, between the corresponding fingers. From FIGS. 14 and 15 it may be noted how the general structure of the sensor FS is substantially similar to the one already described previously, as likewise similar may be the modalities of fabrication employed, for example using techniques of deposition of stacked layers via screen printing. From FIGS. 16-20 there may be appreciated, instead, the different arrangement of the fingers F of the electrodes E, where the distance between adjacent fingers of two distinct electrodes is less than the distance between two consecutive fingers of one and the same electrode.

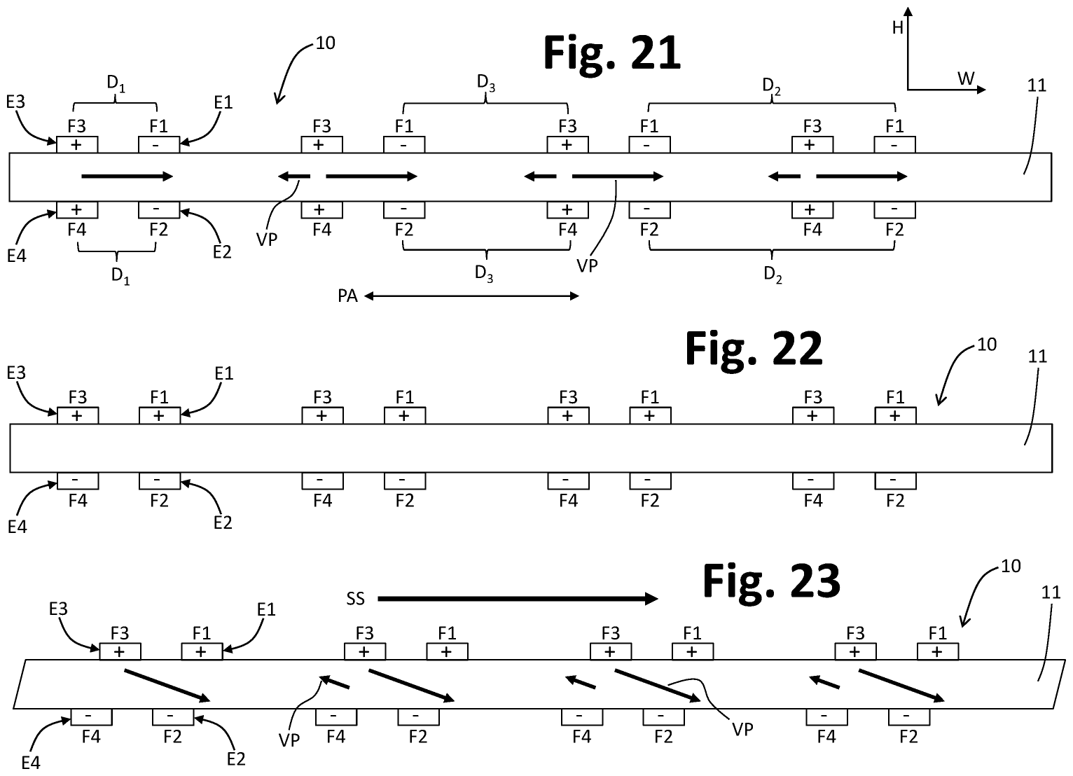

With reference in particular also to FIG. 21, in various embodiments of this type, adjacent fingers F1 and F3 that are closer to one another belonging to the respective upper electrodes E1 and E3 extend (here in the longitudinal direction L) substantially at a first distance D₁ from one another, whereas the distance apart D₂ between two consecutive fingers F1 of one and the same electrode E1 is greater than twice the distance D₁ (in the example, approximately three times the distance D₁); also consecutive fingers F3 of one and the same electrode E3 are substantially at the distance D₂ from one another. It should be noted that also adjacent fingers F1 and F3 that are less close to one another belonging to the respective upper electrodes E1 and E3 extend at a distance apart D₃ that is less than the distance D₂ (in the example, approximately twice the distance D₁).

On the other hand, adjacent fingers F2 and F4 that are closer to one another belonging to the respective lower electrodes E2 and E4 extend (here in the longitudinal direction L) substantially at the aforesaid first distance D₁ from one another, and consecutive fingers F2 of one and the same electrode E2, as likewise consecutive fingers F4 of one and the same electrode E4, are substantially at the aforesaid distance D₂. Also adjacent fingers F2 and F4 that are less close to one another belonging to the respective lower electrodes E2 and E4 extend substantially at the distance D₃ from one another.

From FIG. 21, as well as from the details of FIGS. 18 and 20, it may moreover be noted how each finger F1 of the electrode E1 is in a position substantially overlying or aligned to a respective finger F2 of the electrode E2, and each finger F3 of the electrode E3 is in a position substantially overlying or aligned to a respective finger F4 of the electrode E4.

Also in this case, polarization of the piezoelectric layer 11 is carried out with a configuration of electrical connection of the various electrodes that is different from the configuration of electrical connection that is then used when the piezoelectric transducer 10 has to detect a shear stress.

FIG. 21 represents schematically for this purpose a possible step of polarization of the transducer 10, namely, of the piezoelectric layer 11, in the course of which the electrodes E1 and E2 are electrically connected together to the negative potential (−), and the electrodes E3 and E4 are electrically connected together to the positive potential (+), and are electrically insulated from the other two electrodes E1 and E2. Also in this case, the arrows VP at the centre of the layer 11 represent the polarization vectors, which are determined by application of the potential difference between the electrodes E1 and E2, on the one hand, and the electrodes E3 and E4, on the other hand.

FIG. 22 illustrates, instead, how, in the effective use of the transducer 10 for the purposes of detection of a shear stress, the configuration of electrical connection of the electrodes E1-E4 is different from the one used during polarization of the layer 11. In particular, the upper electrodes E1 and E3 are electrically connected together (here, purely by way of example, to the positive potential +), and the lower electrodes E2 and E4 are electrically connected together (here, purely by way of example, to the negative potential −) and are electrically insulated from the other two electrodes E1 and E3.

In this way, as exemplified in FIG. 23, a shear stress SS applied to the layer 11 in a direction transverse to the longitudinal direction L generates between the electrodes E1 and E3, on the one hand, and the electrodes E2 and E4, on the other hand, a potential difference having a value proportional to the shear stress SS. The variation of the polarization vector that generates a charge on the electrodes may be viewed as a rotation of the polarization vector caused by the shear stress. The reading could be made also by connecting just one pair of electrodes on the opposite faces, for example the electrodes E1 and E2.

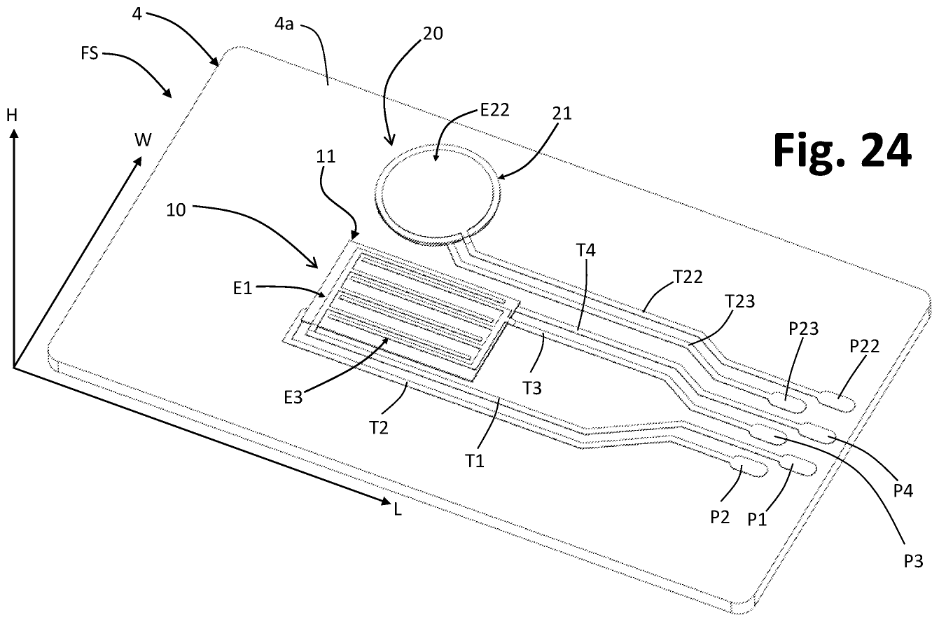

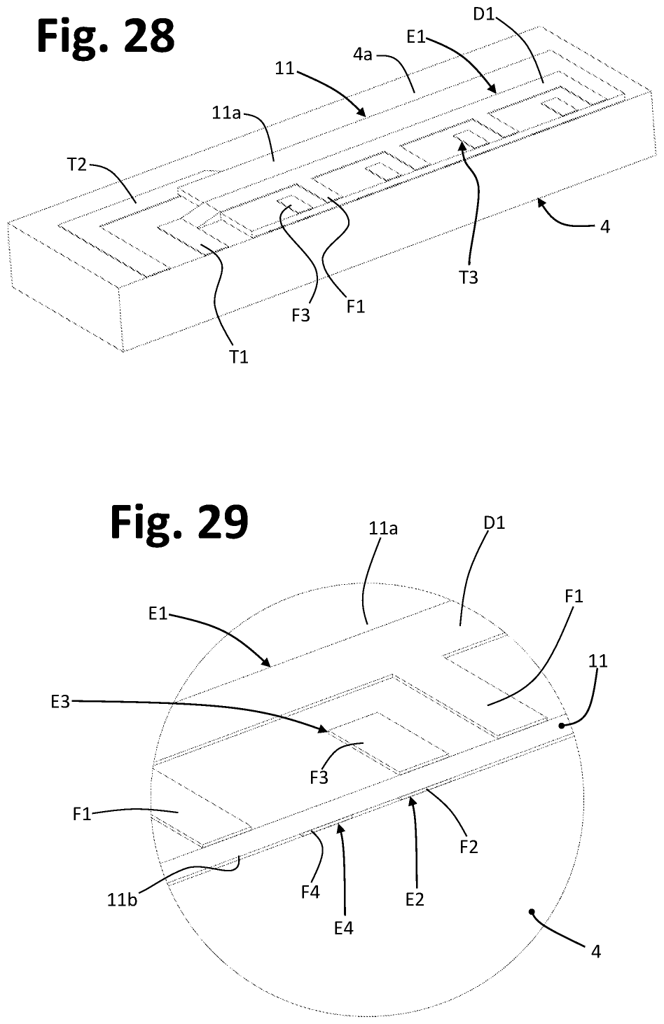

FIGS. 24-32 refer to other embodiments distinguished by an asymmetrical arrangement between the upper electrodes E1, E3 and the lower electrodes E2, E4, namely between the corresponding fingers F, in particular, an arrangement where the fingers of at least one of the upper electrodes E1, E3 are staggered with respect to the fingers of at least one of the lower electrodes E2, E4 in the direction W.

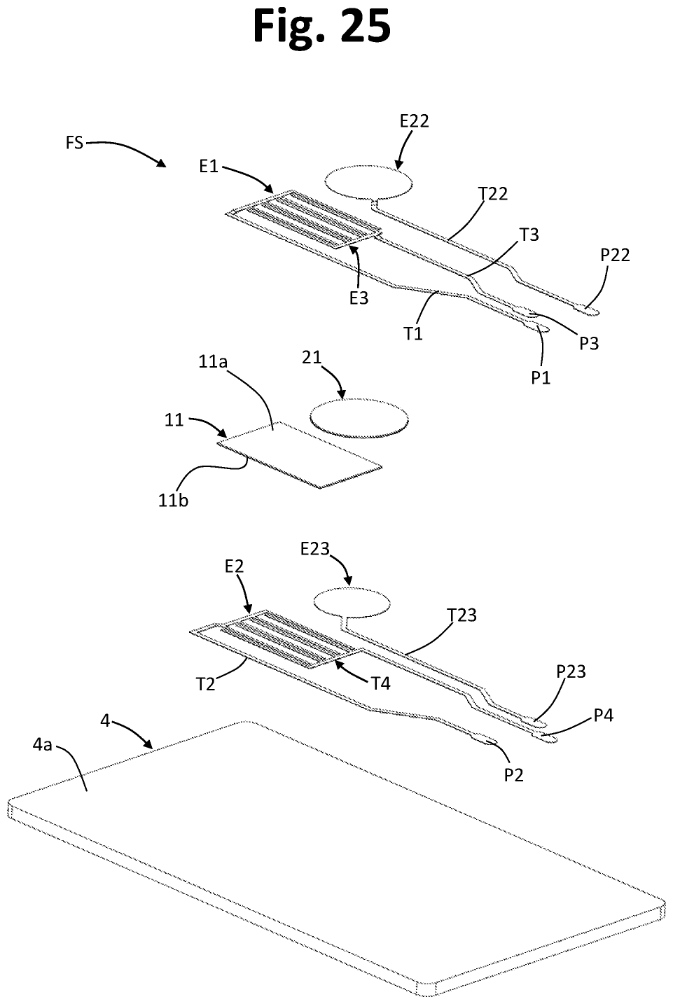

From FIGS. 24 and 25 it may be appreciated how the general structure of the sensor FS is substantially similar to the one illustrated with reference to FIGS. 14-23 (apart from the aforementioned staggered arrangement), as likewise similar may be the modalities of fabrication employed, for example using techniques of deposition of stacked layers by screen printing.

From FIGS. 26-29 there may, instead, be appreciated the different arrangement of the fingers F of the electrodes E: also in this case, the distance between adjacent fingers of two distinct electrodes is less than the distance between two consecutive fingers of one and the same electrode, but the fingers F of an upper electrode are at least in part in a position staggered with respect to the fingers of a lower electrode.

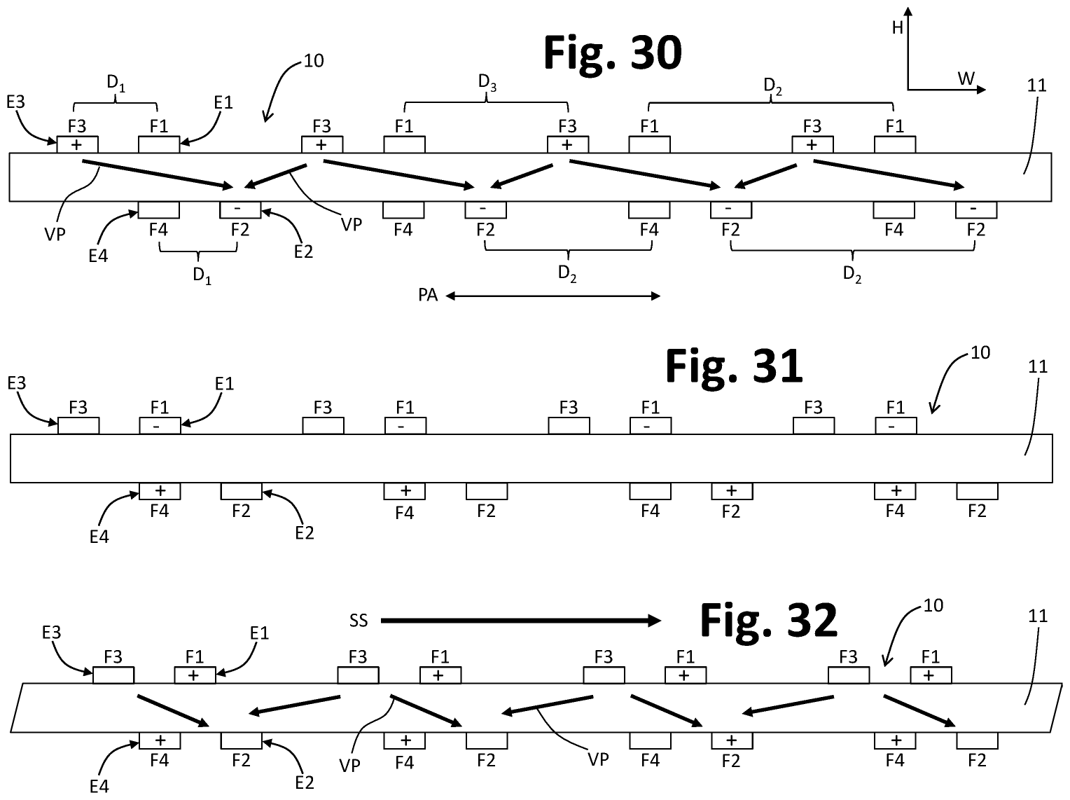

With reference in particular also to FIG. 30, and in a similar way to the case of FIGS. 18-19 and 21-22, in various embodiments of this type adjacent fingers F1 and F3 that are closer to one another belonging to the respective upper electrodes E1 and E3 extend (here in the longitudinal direction L) substantially at a first distance D₁ from one another, whereas the distance D₂ between two consecutive fingers F1 of one and the same electrode E1 is greater than twice the distance D₁ (in the example, approximately three times the distance D₁); also consecutive fingers F3 of one and the same electrode E3 are substantially at the distance D₂ apart. It should be noted that also adjacent fingers F1 and F3 that are less close to one another belonging to the respective upper electrodes E1 and E3 extend at a distance D₃ from one another that is less than the distance D₂ (in the example, approximately twice the distance D₁). On the other hand, adjacent fingers F2 and F4 that are closer to one another belonging to the respective lower electrodes E2 and E4 extend (here in the longitudinal direction L) substantially at the first distance D₁ from one another, and consecutive fingers F2 of one and the same electrode E2, as likewise consecutive fingers F4 of one and the same electrode E4, are substantially at the distance D₂. Also adjacent fingers F2 and F4 that are less close to one another belonging to the respective lower electrodes E2 and E4 extend substantially at the distance D₃ from one another.

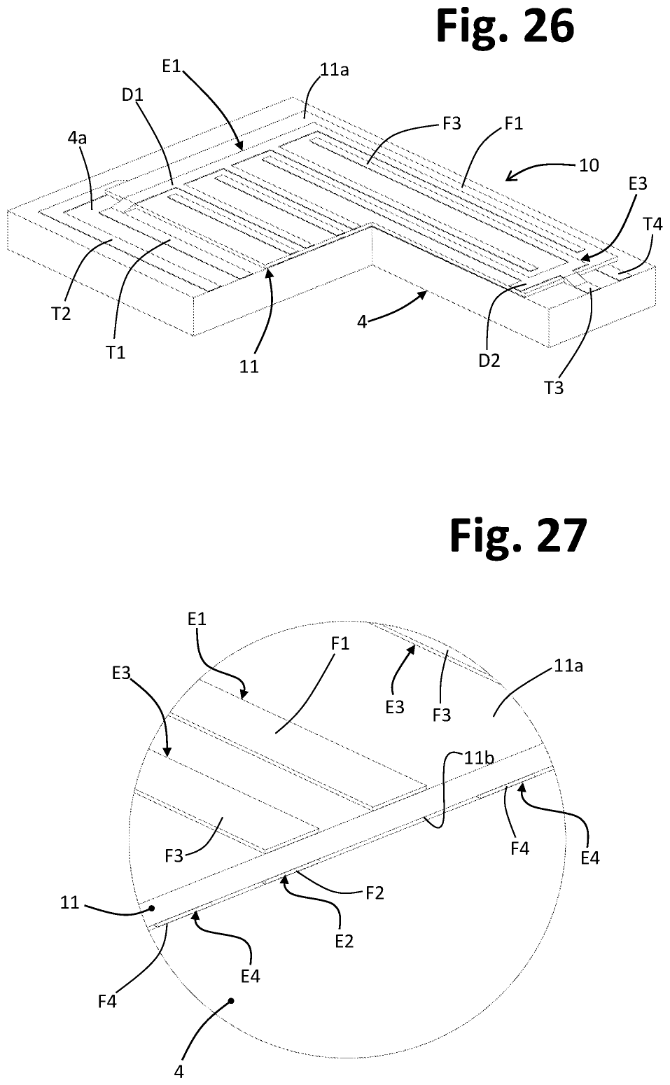

The arrangement of FIGS. 27, 28, and 30 differs from that of FIGS. 18-19 and 21-22 is that each finger F3 of the upper electrode E3 is in a position staggered with respect to a respective finger F4 of the lower electrode E4, and each finger F1 of the upper electrode E1 is in a position staggered with respect to a respective finger F2 of the lower electrode E2, preferably with each finger F1 of the upper electrode E1 in a position substantially overlying or aligned to a respective finger F4 of the lower electrode E4. More in general, each finger F of one of the two upper electrodes E1 and E3 is in a position substantially overlying or aligned to a respective finger F of one of the two lower electrodes E2 and E4, whereas each finger F of the other one of the two upper electrodes E1 and E3 is in a position substantially staggered with respect to a respective finger F of the other one of the two lower electrodes E2 and E4: as has been said, in the example illustrated, the fingers F1 of the upper electrode E1 are in a position overlying or aligned to the fingers F4 of the lower electrode E4, whereas the fingers F3 of the upper electrode E3 are in a position staggered with respect to the fingers F2 of the lower electrode E2.

Also in this case, polarization of the piezoelectric layer 11 is carried out with a configuration of electrical connection of the various electrodes that is different from the configuration employed when the piezoelectric transducer 10 is used for detecting a shear stress.

FIG. 30 represents schematically for this purpose the step for polarization the transducer 10, namely, of the piezoelectric layer 11, in the course of which the four electrodes E1, E2, E3, and E4 are electrically insulated from one another, and the potential difference is applied between one of the two upper electrodes, here the electrode E3, set at a positive potential (+), and one of the two lower electrodes, here the electrode E2, set at a negative potential (−), where the two electrodes to which the potential difference is applied are preferably the ones whose fingers F are in a mutually staggered position (here the fingers F3 and F2 of the electrodes E3 and E2). Once again, the arrows VP at the centre of the layer 11 represent the polarization vectors, which are determined by application of the potential difference between the electrodes E3 and E2. A signal corresponding to the shear stress would be obtained also by carrying out polarization between the electrodes E1 and E4, and then measuring the deformation using the electrodes E3 and E2, but there would be a greater effect on the signal from the normal compression, which, instead, in general is to be uncoupled.

The polarization vectors VP may have a different value, given a different distance between the fingers F3 of the electrodes E3 set at a positive potential (+), and respective fingers F2 of the lower electrodes E2 set at a negative potential (−); the layer 11 may have areas with different polarization.

FIG. 31 illustrates, instead, how in the effective use of the transducer 10, the electrodes E1-E4 are electrically connected in a configuration different from the one used during polarization of the layer 11. In particular, the four electrodes E1, E2, E3 and E4 are once again electrically insulated from one another, and between the electrodes E1 and E4 the potential difference induced in the layer 11 following upon a shear stress is detected (in the non-limiting example illustrated, the electrode E1 detects the negative potential − and the electrode E4 detects the positive potential +). It will thus be appreciated that, preferably, the electrodes E used for the purposes of detecting a shear stress are the electrodes whose fingers are in a position substantially overlying, or aligned to, one another.

In this way, as exemplified in FIG. 32, a shear stress SS applied to the layer 11 in a direction transverse to the longitudinal direction L generates between the electrodes E1 and E4 a potential difference having a value proportional to the aforesaid shear stress SS. The variation of the polarization vector that generates a charge on the electrodes may be viewed as a rotation of the polarization vector caused by the shear stress.

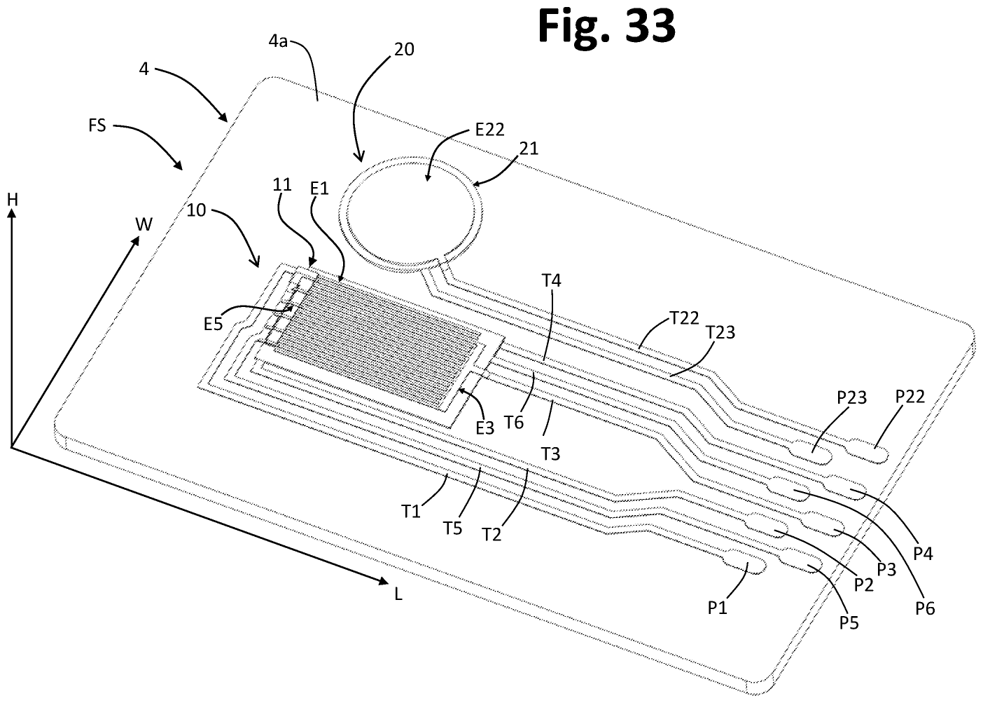

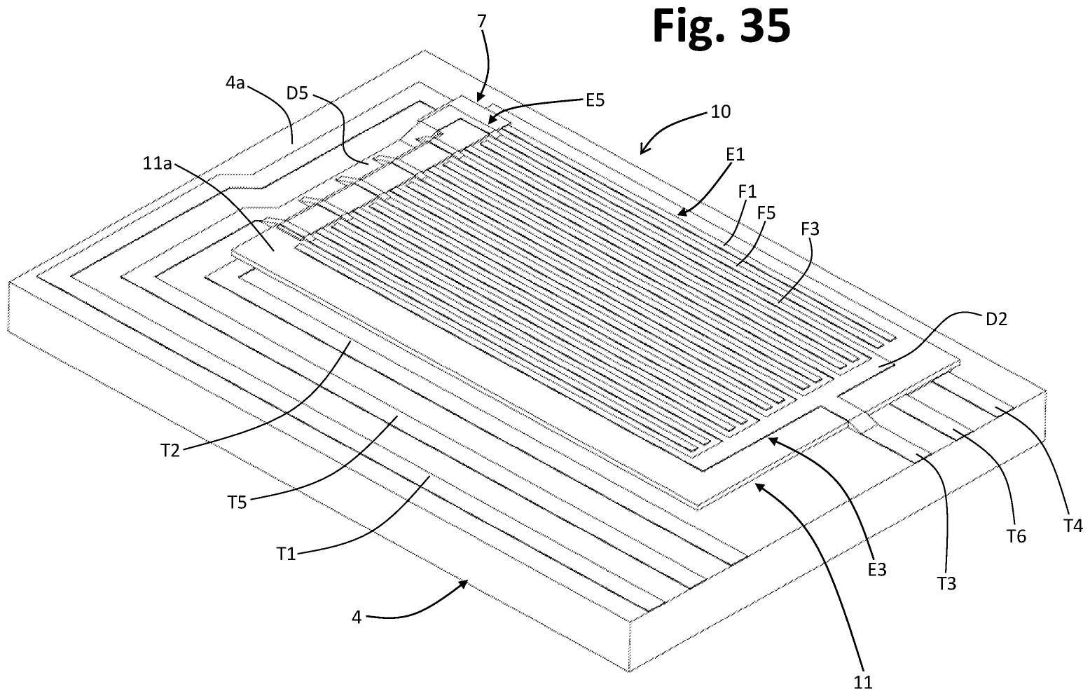

In the examples of embodiment described previously, associated to the piezoelectric layer 11 are two upper comb-like electrodes E1 and E3 and two lower comb-like electrodes E2 and E4. However, in other embodiments, the number of comb-like electrodes could be greater and/or the number of upper electrodes, and/or upper fingers could be different from the number of lower electrodes and/or lower fingers. FIGS. 33-44 refer, for example, to embodiments that envisage, in addition to the electrodes E1-E4, also at least two further electrodes, and in particular a further comb-like upper electrode E5 and a further comb-like lower electrode E6, each having a plurality of fingers F5 and F6, preferably spaced at equal distances apart, which extend in the longitudinal direction L at the two opposite faces 11a and 11b of the piezoelectric layer 11. Also the fingers F5 of the electrode E5 are interdigitated or alternating with the fingers F1 and F3 of the other two upper electrodes, and the fingers F6 of the electrode E6 are interdigitated or alternating with the fingers F2 and F4 of the other two lower electrodes.

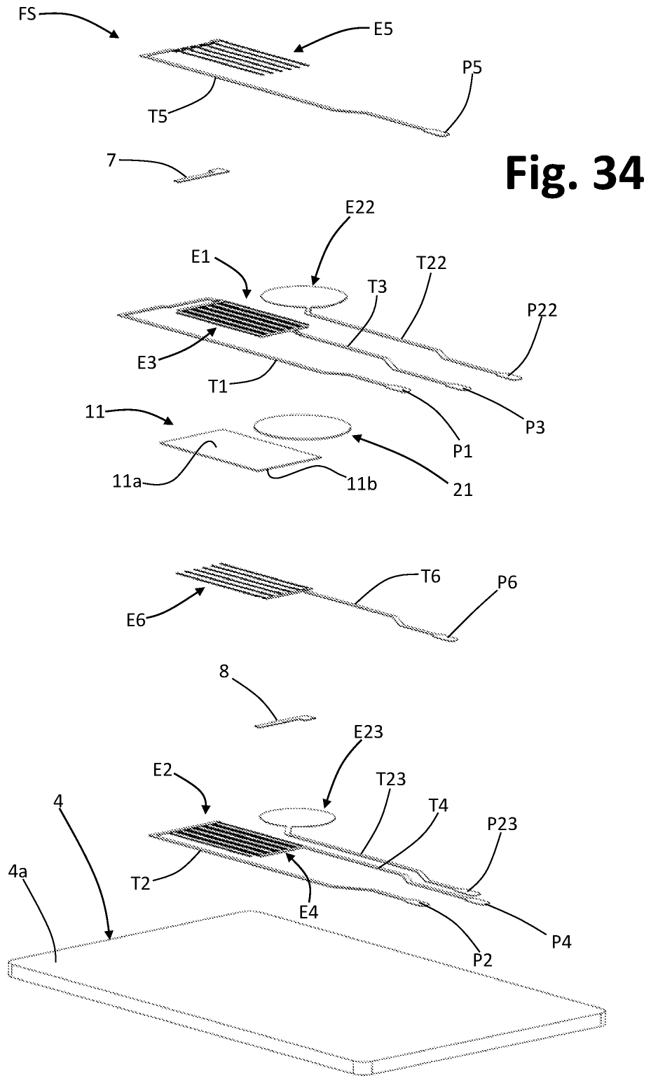

From FIGS. 33 and 34 it may be appreciated how the general structure of the sensor FS is substantially similar to the one described previously, as likewise similar may be the modalities of fabrication employed, for example using techniques of deposition of stacked layers by screen printing. The electrodes E5 and E6 are preferably formed using the same technique as the one used to form the electrodes E1 and E3, on the one hand, and E2 and E4, on the other hand, and in the same production step.

It should be noted that in this case, given the presence of three electrodes at each major face of the layer 11, also layers of electrically insulating material are preferably provided. The presence of these electrically insulating layers, which also can be deposited using the same techniques of deposition as those used for the layer 11 and/or the electrodes E or the tracks T (obviously using electrically insulating materials), enables simplification of design of the electrodes and their deposition, eliminating risks of short-circuiting between the distribution portions D of the electrodes E.

For instance, with reference to FIG. 34, designated by 7 is an insulation layer, designed to overlie at least in part the distribution portion D1 of the electrode E1 in order to prevent electrical contact thereof with the electrode E5. Likewise, the insulation layer designated by 8 is designed to overlie at least in part the distribution portion D2 of the electrode E2 in order to prevent electrical contact thereof with the electrode E6.

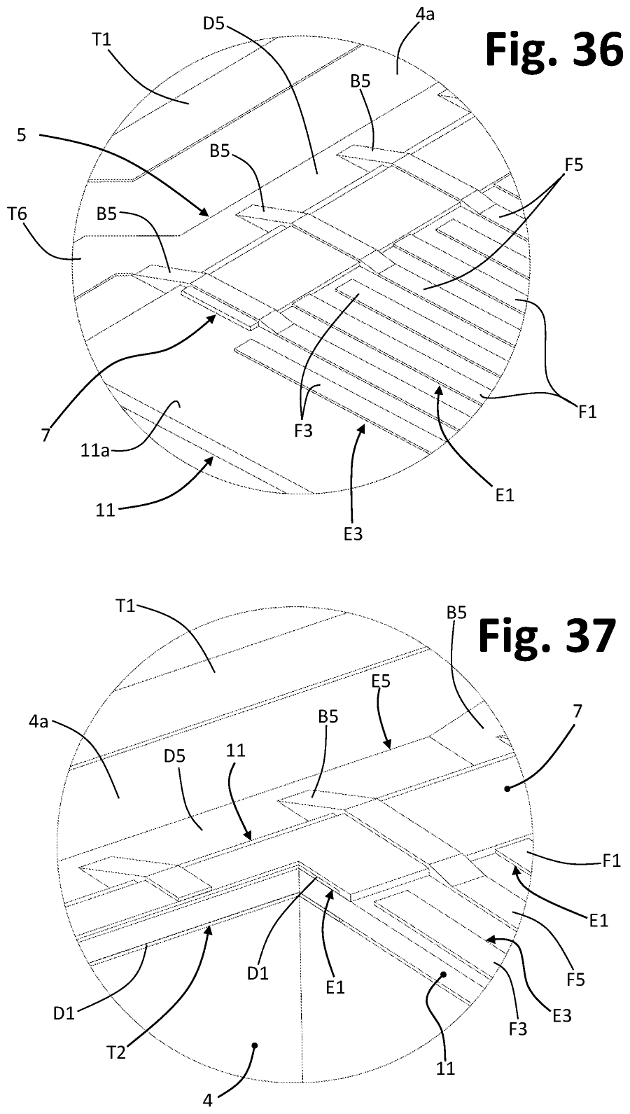

In particular, from FIGS. 36 and 37 there may be noted the position of the layer 7 and how the latter covers at least in part the portion D1 of the electrode E1, as well as possibly a small initial stretch of the corresponding fingers F1, which are located on the upper face 11a of the piezoelectric layer 11. From the same figures, it may be noted how the distribution portion D5 of the electrode E5 is preferably located on the face 4a of the substrate 4, and how from this distribution portion D5 there depart portions of conductive track B5 that substantially span the insulating layer 7, for electrical connection to the corresponding fingers F5.

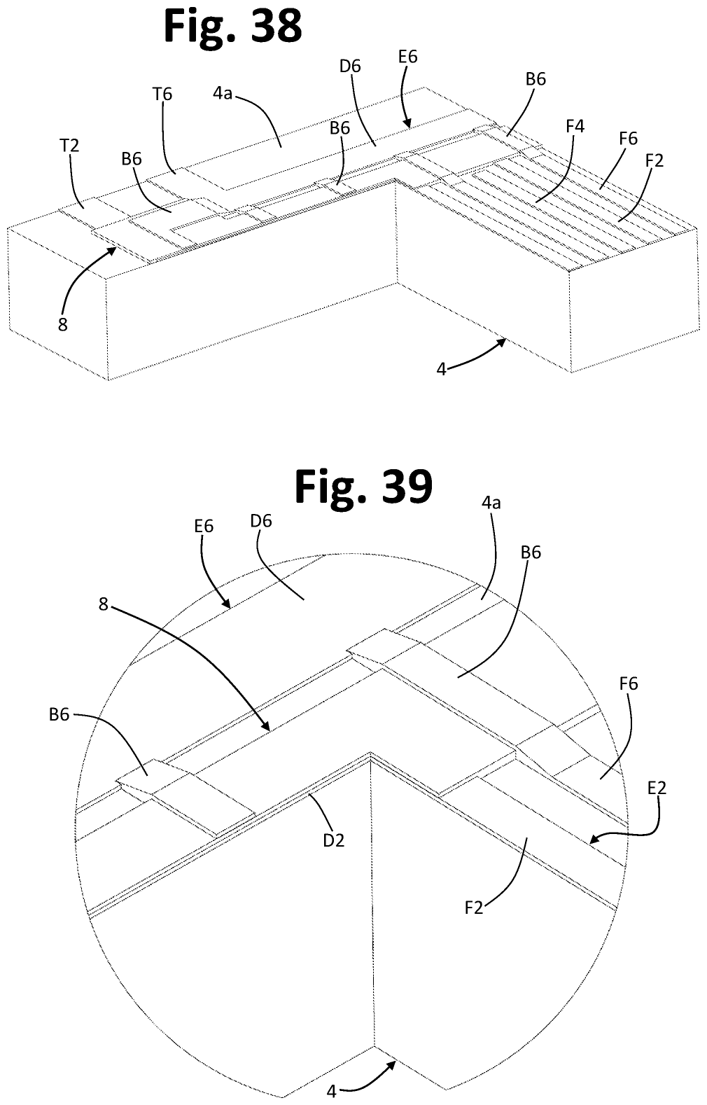

FIGS. 38 and 39 highlight, instead, the position of the insulating layer 8: it should be noted that these figures illustrate the substrate 4 with some tracks T and some electrodes E, in a condition that precedes deposition of the piezoelectric layer 11. As may be appreciated, in particular from FIG. 39, the insulating layer 8 covers at least in part the distribution portion D2 of the lower electrode E2, as well as possibly a small initial stretch of the corresponding fingers F2, which are located on the face 4a of the substrate 4. Also the distribution portion D6 of the electrode E6 is preferably located on the face 4a of the substrate 4, and from this distribution portion D6 there depart respective portions of conductive track B6 that substantially span the insulating layer 8, for connection to the corresponding fingers F6.

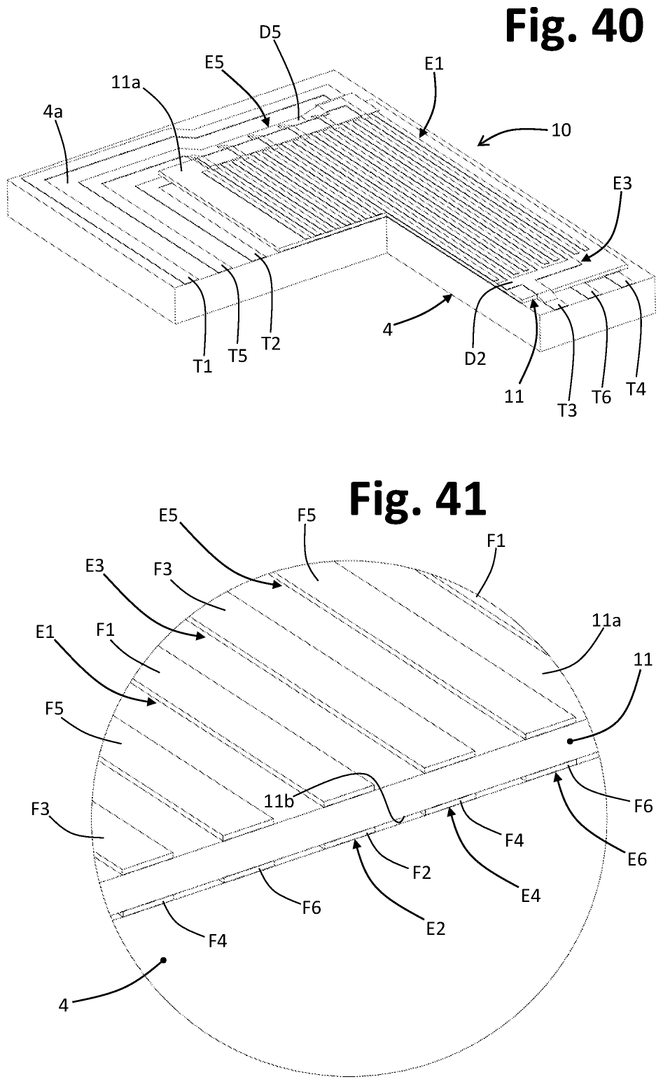

From FIGS. 40-41 there may, instead, be appreciated the arrangement of the fingers F of the six electrodes E, where the distance between adjacent fingers of two distinct electrodes is less than the distance between two consecutive fingers of one and the same electrode, and where the fingers F of the upper electrodes E1, E3, E5 substantially overlie, or are aligned with, the fingers F2, F4, F6 of the lower electrodes E2, E4, E6, respectively.

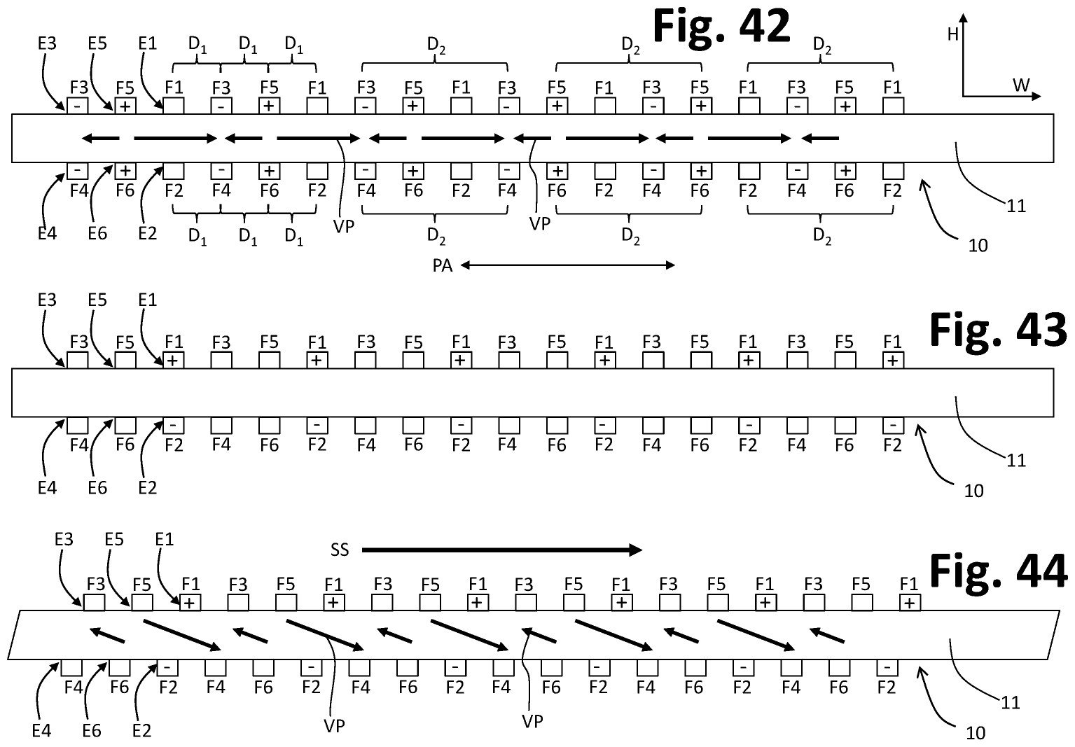

With reference, in particular, also to FIG. 42, adjacent fingers F1, F3, and F5 of the respective upper electrodes E1, E3, and E5 extend (here in the longitudinal direction L) substantially at a first distance D₁ from one another, i.e., with a substantially constant pitch. The distance D₂ between consecutive fingers F1 of one and the same electrode E1, as likewise between consecutive fingers F3 of one and the same electrode E3 and between consecutive fingers F5 of one and the same electrode E5, is substantially not less than three times the distance D₁, preferably approximately three times the distance D₁.

Alternatively, the distances between at least some of the fingers F of the upper electrodes E could be at least in part different from one another and/or the distances between at least some of the fingers F of the lower electrodes E could be at least in part different from one another.

The shape and arrangement of the fingers F of the lower electrodes E2, E4, and E6 are substantially specular to those of the fingers F of the upper electrodes F1, F3, and F5. Consequently, also adjacent fingers F2, F4, and F6 of the respective lower electrodes E2, E4, and E6 are substantially at the distance D₁ from one another, and the distance D₂ between consecutive fingers F2 of one and the same electrode E2, as likewise between consecutive fingers F4 of one and the same electrode E4 and between consecutive fingers F6 of one and the same electrode E6, is not less than three times the distance D₁, preferably equal to approximately three times the distance D₁. Once again from FIGS. 41 and 42 it may be noted how each finger F1, F3 and F5 of the upper electrodes E1, E3, and E5 is in a position substantially overlying or aligned to a corresponding finger F2, F4, and F6, respectively, of the lower electrodes E2, E4, and E6.

Also in this case, polarization of the piezoelectric layer 11 is carried out with a configuration of electrical connection of the various electrodes E1-E6 that is different from the configuration of electrical connection employed when the piezoelectric transducer 10 is used for detecting a shear stress.

FIG. 42 represents schematically for this purpose the step of polarization of the transducer 10, namely, of the piezoelectric layer 11, during which:
a first pair of electrodes, whose fingers overlie one another, (and hence the electrodes E1 and E2, or else the electrodes E3 and E4, or else the electrodes E5 and E6) is electrically insulated from the other electrodes, with the two electrodes of the first pair that are also electrically insulated from one another;
a second pair of electrodes (different from the first pair), whose fingers overlie one another, is electrically insulated from the other electrodes, but the two electrodes of the second pair are electrically connected together;
the remaining third pair of electrodes (different from the first and second pairs), whose fingers overlie one another, is electrically insulated from the other electrodes, but the two electrodes of the third pair are electrically connected together; and
the potential difference necessary for polarization is applied between the second pair of electrodes, on the one hand, and the third pair of electrodes, on the other hand.

In the specific example of FIG. 42, the aforesaid first pair is formed by the electrodes E1 and E2, the second pair is formed by the electrodes E3 and E4, which are connected to the negative potential (−), and the third pair is formed by the electrodes E5 and E6, which are connected to the positive potential (+). Also in this case, the arrows VP at the centre of the layer 11 represent the polarization vectors, determined by application of the potential difference between the electrodes E3-E4, on the one hand, and the electrodes E5-E6, on the other hand.

FIG. 43 illustrates, instead, how, during effective use of the transducer 10, the configuration of electrical connection of the electrodes E1-E6 is different from the one used during polarization of the layer 11. In particular, all six electrodes E1-E6 are electrically insulated from one another, and the shear stress SS applied to the piezoelectric layer 11 in a direction transverse to the longitudinal direction L generates—between two electrodes whose fingers F overlie one another—the potential difference having a value proportional to the shear stress SS. Preferably, as in FIG. 43, the electrodes used for detecting the intensity of the shear stress SS are the ones not used during polarization, i.e., those of the aforementioned first pair (in the example illustrated, the electrodes E1 and E2, or the corresponding fingers F1 and F2).

In this way, as exemplified in FIG. 44, a shear stress SS applied to the layer 11 in a direction transverse to the longitudinal direction L generates between the electrodes E1 and E2 a potential difference having a value proportional to the aforesaid shear stress SS. The variation of the polarization vector that generates a charge on the electrodes may be viewed as a rotation of the polarization vector caused by the shear stress.

Of course, also the piezoelectric layer 21 of the transducer 20 must be previously subjected to polarization. In the case of the piezoelectric layer 21, the corresponding polarization axis extends in a direction (H) transverse to a plane identified by the layer 21, as indicated in FIG. 5: in this case, the electrodes used during reading coincide with those used during polarization.

In various applications, the mechanical-stress sensor FS described previously may be provided with a casing of its own.

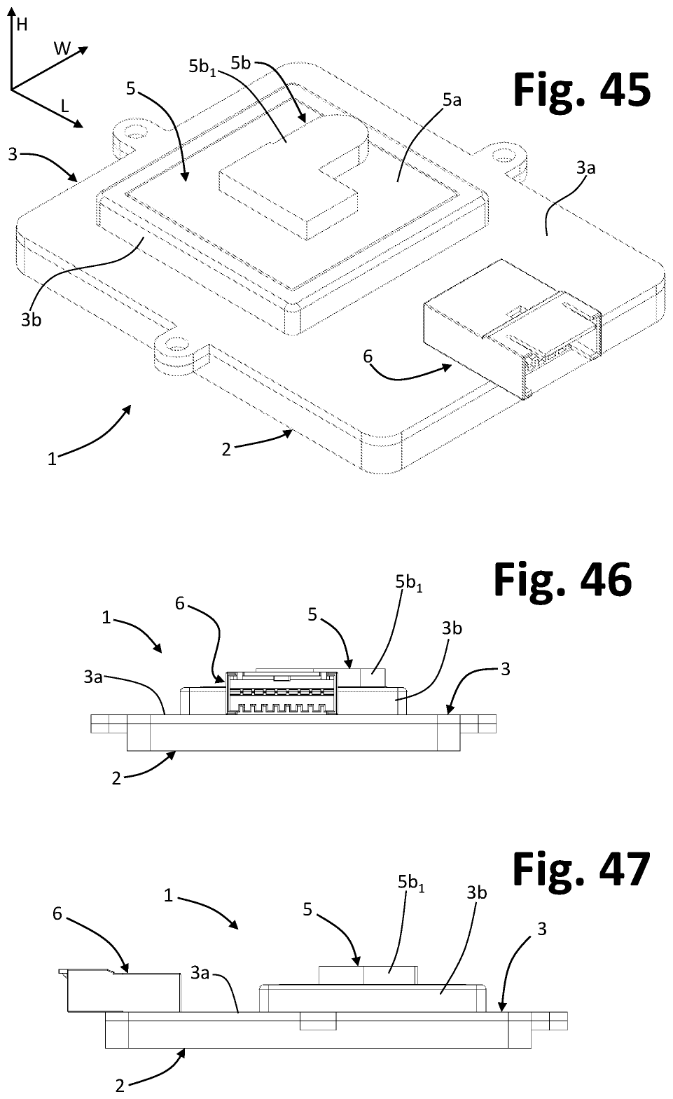

With reference, for example, to FIGS. 45-47, designated as a whole by 1 is a sensor device that integrates a mechanical-stress sensor FS according to possible embodiments described previously. The sensor device 1 has a supporting structure, which, in various embodiments, is configured for being fixed in a stationary position. In various embodiments, such as the one exemplified, the supporting structure comprises at least two parts 2 and 3, for example made of thermoplastic or metal material, which can be coupled to one another to form a container or casing.

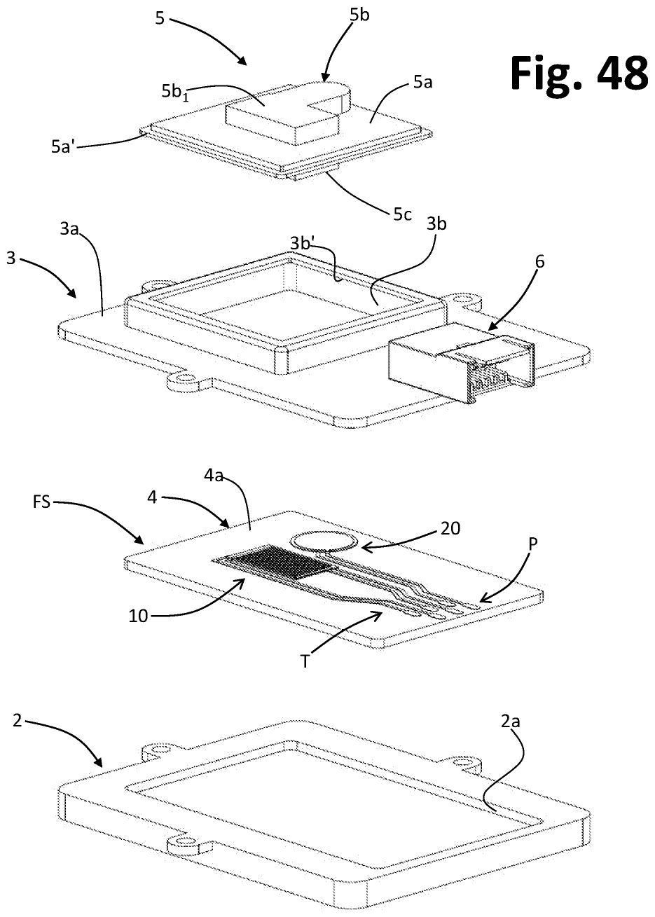

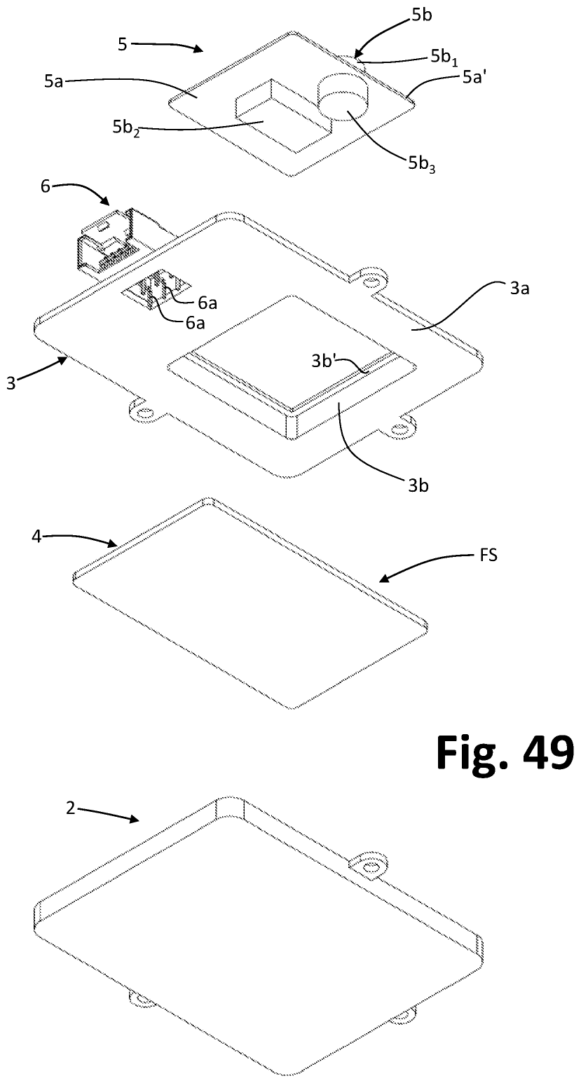

With reference also to FIGS. 48-49, in various embodiments, the casing part 2 provides a base, associated to or mounted on which is the planar substrate 4 described previously. Alternatively, the substrate 4 could be integrated or form part of the supporting structure 2 or 3 of the device 1, for example being obtained by deposition by screen printing or by mounting at least some of the electrodes and/or at least one piezoelectric layer on at least one of the parts 2 and/or 3.

The substrate 4 is preferably mounted in a fixed position on the casing part 2. For this purpose, in various embodiments, the part 2 defines a seat 2a, configured for receiving at least part of the substrate 4, possibly provided with engagement or fixing reliefs or elements and/or positioning elements for the substrate 4.

The substrate 4 may be fixed in position within the seat 2a (e.g., glued, welded, engaged, secured via screws or the like), or else the profile of the substrate 4 may be substantially complementary to that of the seat 2a, or in any case such that the former is received in the latter in the absence of play, possibly with slight interference, for relative positioning and/or fixing thereof.

The casing part 3 substantially provides a lid, with a respective wall 3a that, after the part 3 has been set on top of the part 2, enables the seat 2a to be closed at least at its peripheral region, for example to secure and/or position the substrate 4 within the seat 2a.

In various preferential embodiments, the sensor 1 comprises a detection part, designated as a whole by 5, which can perform movements or undergo deformations relative to the supporting structure, here comprising the parts 2, 3 and the substrate 4. The capacity of displacement or deformation of the part 5 is aimed at detecting mechanical stresses, namely, shear stresses, by means of the transducer 10, and possibly normal stresses. For this purpose, in various embodiments, the part 5 is mechanically associated to the transducer 10 of the sensor FS integrated in the device 1, and possibly also to the transducer 20, if envisaged. For instance, assuming that the sensor device 1 is an accelerometer, its part 5 may be assumed as being a seismic mass.

As may be seen in particular in FIGS. 48 and 49, in various embodiments, the wall 3a of the part 3 defines a through opening 3b where the detection part 5 is mounted. The opening 3b may, for example, be delimited peripherally by a substantially tubular formation that rises from the wall 3a. In the non-limiting example, the part 5 comprises a wall 5a having a peripheral profile 5a′ that is shaped for coupling to a corresponding peripheral profile or edge 3b′ of the opening 3b, preferably in such a way that the element 5 will be withheld within the opening 3b with the possibility of minor lateral displacements, i.e., at least in the directions L and/or W, and possibly also of albeit minimal axial displacements in the direction H.

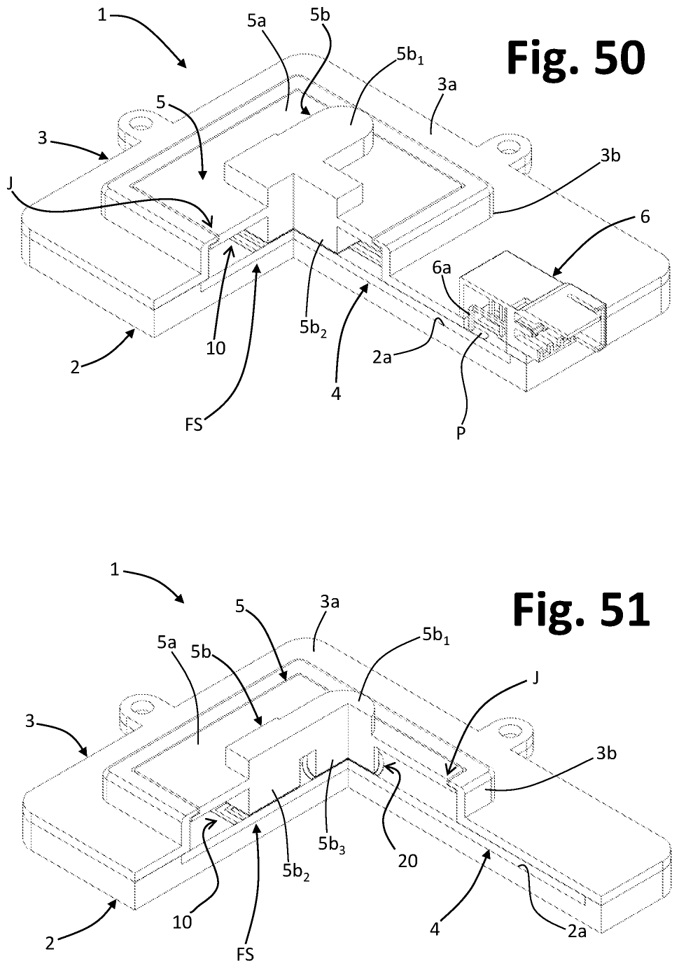

For instance, once again with reference to the non-limiting example illustrated, the profile 5a′ comprises a step formed along the peripheral edge of the wall 5a, whereas the opening 3b has a respective projecting edge that provides the profile 3b′ and is designed for engagement with the aforesaid step. As may be appreciated, for example, from the details designated by J in FIGS. 50 and 51, the arrangement exemplified is such that the element 5 may be inserted from beneath through the opening 3b of the casing part 3, in such a way that the element 5 itself cannot be slid out from above after the casing part 3 has been fixed to the underlying casing part 2.

In various embodiments, the wall 5a of the detection part 5 comprises a central element 5b, preferably having a respective upper portion 5b₁, which projects upwards, and at least one lower portion 5b₂ and/or 5b₃ (see, in particular, FIG. 49), which projects downwards. The aforesaid central element 5b, or its portions 5b₁-5b₃, is or can be formed integrally with the wall 5a, or else be configured as part applied thereto.

As seen previously, in various embodiments, the sensor FS integrated in the device 1 includes two different piezoelectric transducers, i.e., those designated by 10 and 20 also in FIGS. 50-51, which are represented as distinct elements but could also have some elements or parts in common, such as electrode parts or a single piezoelectric layer, also with areas polarized differently. For this purpose, in the example illustrated, the central element 5b comprises two different lower portions 5b₂ and 5b₃, which are to co-operate with the transducer 10 and the transducer 20, respectively. As may be appreciated, the lower portion 5b₂ is designed to rest on the transducer 10, whereas the lower portion 5b₃ is designed to rest on the transducer 20. Preferably, the portion 5b₂ is mechanically constrained to the transducer 10 (e.g., glued thereon), or in any case overlies it resting thereon or being adherent or constrained thereto in such a way that a displacement in the transverse direction of the detection part 5 will be transferred to the transducer 10. On the other hand, since the transducer 20 is preferably a pressure transducer, it is not strictly necessary for the lower portion 5b₃ to be constrained to the transducer 20, since it is in fact sufficient for a displacement downwards of the aforesaid portion 5b₃ to cause a compression of the transducer 20. It goes without saying that the lower portions 5b₂ and 5b₃ could be replaced by a single lower portion that overlies both of the transducers 10 and 21.

In various embodiments, the upper portion 5b₁ of the central element 5b is designed to be associated to a generic object a displacement of which is to be detected, but it will be appreciated that the aforesaid upper portion could have a configuration different from the one exemplified, or even be omitted, for example by constraining the aforesaid object directly to the wall 5a of the detection part. The detection part 5 could even be absent, with the object in question associated directly at least to the transducer 10. Likewise, also each lower portion 5b₂ and/or 5b₃ of the central element 5b could be shaped differently from what has been illustrated or even be omitted. As has been said, the part 5 (with or without the central element 5b) can itself constitute the detected element (for example, when the part 5 provides the seismic mass of an accelerometer).

Finally, the device 1 comprises a connector 6, for electrical connection to an external system. The connector 6 has a respective connector body, which is associated to at least one of the casing parts 2 and 3 (in the example, the part 3) or integrated in the aforesaid casing parts, such as a body part 3 shaped for providing at least part of an electrical connector 6. Located within the connector body are electrical terminals (some of which are designated by 6a in FIGS. 49-50), each having an inner end designed to be set in electrical contact with a respective pad P provided on the substrate 4. FIG. 49 exemplifies the case of six terminals 6a, but evidently in the case of a device that integrates a sensor FS according to FIGS. 33-44, the terminals 6a will be eight (six for the transducer 10 and two for the transducer 20). In the case of a casing body that is able to withstand the temperatures of treatment of the layer 11 necessary for polarization of the layers 11 and/or 20, the connector 6 can be exploited first for connection to production equipment used for carrying out polarization, with a first configuration of electrical connection according to what has been described previously; then, upon installation of the device 1, the same connector 6 can be exploited for electrical connection of the transducers 10 and/or 20 to an external system that uses the detections made, with a second configuration of electrical connection according to what has been described previously.

From what has been described it may be appreciated how the production and operation of the stress sensor according to the invention are simple and reliable.

A substantial advantage of the stress sensor described is represented by the fact that it can be provided right from the start with a given structure of the electrodes, which is exploited both in the production stage, in order to polarize the material, in a first configuration of electrical connection, and subsequently also during final use of the sensor for purposes of detection, in a second configuration of electrical connection. In this way, the problem of having to provide in a first stage of fabrication polarization electrodes and in a subsequent step of fabrication detection electrodes is obviated; i.e., it is not necessary to resort to complicated assemblages and replacements of electrodes as is, instead, typical of the prior art (see, for example, Marcelo Areias Trindade, et al., “Evaluation of effective material properties of thickness-shear piezoelectric macro fibre composites”, in Proceedings of COBEM 2011, 21st International Congress of Mechanical Engineering, Oct. 24-28, 2011, Natal, RN, Brazil). The invention hence also enables a simplification of the equipment and/or of the processes of production.

It is clear that numerous variations may be made by the person skilled in the art to the sensor and the method described by way of example, without thereby departing from the scope of the invention as defined by the ensuing claims. It is likewise clear that individual characteristics described with reference to embodiments described above may be combined with one another in other embodiments.

The component previously designated by 5 could be provided integrally with a part of the casing of the sensor FS; for example, it could constitute a portion of the casing part 3 itself. An integral portion of this sort could, for example, be made of an elastomeric material (preferably overmoulded on a stiffer body of the casing part 3), designed to transmit the albeit minimal movements in the directions L and/or W and/or H.

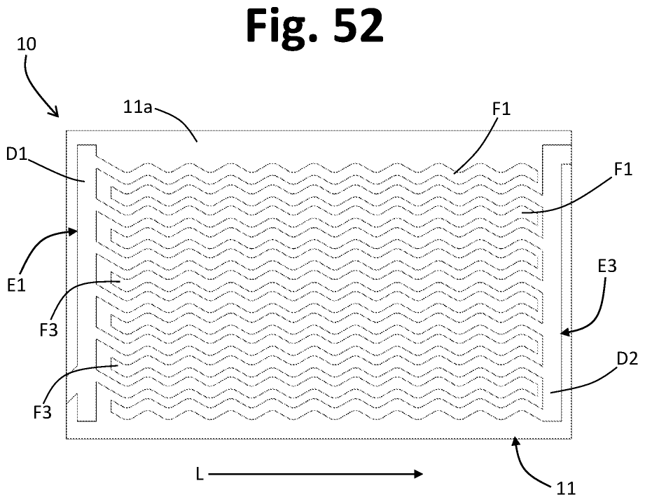

As has been mentioned, the substantially rectilinear shape of the fingers F, however preferable, does not constitute an essential characteristic. The fingers could in fact have a development distinguished by stretches that are curved and/or angled with respect to the longitudinal direction L, such as S-shaped or zigzag-shaped electrodes. Such a case is exemplified in FIG. 52, which shows the electrodes E1 and E3; in this embodiment, the corresponding lower electrodes (not represented) will have a similar longitudinal development.

The distances referred to in the examples provided previously, such as the distances D₁ and/or D₂ and/or D₃, must be understood preferential but non-limiting; namely, the distances between the fingers of the electrodes and/or the corresponding alignment or staggering could be different from those shown by way of example. In the non-limiting examples provided, polarization and detection of shear stress have been described with reference to the fingers F that extend in one and the same direction (here the longitudinal direction L). However, also other portions of the electrodes E could contribute to detection, such as the portions D of the electrodes that join the fingers F, in particular in the case of shear stresses having at least one component in the direction of extension of the fingers (as in the case of FIG. 13). More in general, in various embodiments, the electrodes E may envisage both first portions F that extend in a first direction (here the direction of length L) and second portions D that extend in a direction transverse to the aforesaid first portions F (here the direction of width W), with the aforesaid portions D and F of the electrodes E that can participate in polarization and/or measurement.

The electrodes could be shaped so as to extend, instead of in at least one between a longitudinal direction L and a direction of width W of the layer of piezoelectric material 11, in a direction that is angled or diagonal with respect to the aforesaid longitudinal direction or direction of width.

1. A mechanical-stress sensor, comprising a supporting structure and at least one first piezoelectric transducer on the supporting structure, configured for detecting a displacement or a deformation, the first piezoelectric transducer being able to generate a first electrical signal representing a shear stress, the first piezoelectric transducer comprising:
a first layer of piezoelectric material, which extends in a longitudinal direction and has a first major face and a second major face opposite to one another, the first layer of piezoelectric material having at least one polarization axis that extends in a direction transverse to the longitudinal direction;
at least one first electrode and one second electrode, each having a plurality of portions or fingers, which extend at the first and second major faces of the first layer of piezoelectric material, respectively,
wherein the first piezoelectric transducer comprises at least one third electrode and one fourth electrode, each having a plurality of portions or fingers, which extend at the first and second major faces of the first layer of piezoelectric material, respectively, the portions or fingers of the third electrode being interdigitated or alternating with the portions or fingers of the first electrode, and the portions or fingers of the fourth electrode being interdigitated or alternating with the portions or fingers of the second electrode.

2. The mechanical-stress sensor according to claim 1, wherein the first, second, third and fourth electrodes are substantially comb-like electrodes.

3. The mechanical-stress sensor according to claim 1, wherein at least some from among the first electrode, the second electrode, the third electrode and the fourth electrode are electrodes for polarization of the first layer of piezoelectric material or are both electrodes for polarization of the first layer of piezoelectric material and electrodes for measuring a signal generated by said first layer of piezoelectric material.

4. The mechanical-stress sensor according to claim 1, wherein:
the portions or fingers of the first and third electrodes extend at least in the longitudinal direction substantially at a first distance from one another, and the portions or fingers of the first electrode, respectively the portions or fingers of the third electrode, are at a mutual distance which is substantially not less than twice the first distance,
the portions or fingers of the second and fourth electrodes extend at least in the longitudinal direction substantially at the first distance from one another, and the portions or fingers of the second electrode, respectively the portions or fingers of the fourth electrode, are at a mutual distance which is substantially not less than twice the first distance.

5. The mechanical-stress sensor according to claim 4, wherein the first and third electrodes, or the respective portions or fingers, are electrically connected together and the second and fourth electrodes, or the respective portions or fingers, are electrically connected together and electrically insulated from the first and third electrodes, in such a way that a shear stress applied to the first layer of piezoelectric material at least in the longitudinal direction generates between the first and third electrodes, on the one hand, and the second and fourth electrodes, on the other hand, a potential difference having a value proportional to said shear stress.

6. The mechanical-stress sensor according to claim 1, wherein:
the portions or fingers of the first and third electrodes extend in the longitudinal direction substantially at a first distance from one another, the portions or fingers of the first electrode being at a second mutual distance which is greater than twice the first distance, and the portions or fingers of the third electrode being substantially at the second distance from one another,
the portions or fingers of the second and fourth electrodes extend in the longitudinal direction substantially at the first distance from one another, the portions or fingers of the second electrode, respectively the portions or fingers of the fourth electrode, being substantially at the second mutual distance.

7. The mechanical-stress sensor according to claim 6, wherein:
each said portion or finger of the first electrode s in a position substantially overlying or aligned to a respective one said portion or finger of the second electrode, and each said portion or finger of the third electrode is in a position substantially overlying or aligned to a respective one said portion or finger of the fourth electrode; or else
each said portion or finger of one of the first electrode and or the third electrode is in a position substantially overlying or aligned to a respective one said portion or finger of one of the second electrode or the fourth electrode, and each said portion or finger of the other one of the first electrode or the third electrode is in a position substantially staggered with respect to a respective one said portion or finger the other one of the second electrode or the fourth electrode.

8. The mechanical-stress sensor according to claim 7, wherein:
each said portion or finger of the first electrode is in a position substantially overlying or aligned to a respective one said portion or finger of the second electrode, and each said portion or finger of the third electrode is in a position substantially overlying or aligned to a respective one said portion or finger of the fourth electrode, and the first and third electrodes, or the respective said portions or fingers, are electrically connected together, and the second and fourth electrodes, or the respective said portions or fingers, are electrically connected together and electrically insulated from the first and third electrodes, in such a way that a shear stress applied to the first layer of piezoelectric material in a direction transverse to the longitudinal direction generates between the first and third electrodes, on the one hand, and the second and fourth electrodes, on the other hand, a potential difference having a value proportional to said shear stress; or else
each said portion or finger of one of the first electrode and or the third electrode is in a position substantially overlying or aligned to a respective one said portion or finger of one of the second electrode and or the fourth electrode, and each said portion or finger of the other one of the first electrode or the third electrode is in a position substantially staggered with respect to a respective one said portion or finger of the other one of the second electrode and or the fourth electrode, and the first and third electrodes, or the respective said portions or fingers, are electrically insulated from one another, and the third and fourth electrodes, or the respective said portions or fingers, are electrically insulated from one another and from the first and third electrodes, in such a way that a shear stress applied to the first layer of piezoelectric material in a direction transverse to the longitudinal direction generates between one of the first electrode or the third electrode, on the one hand, and one of the second electrode and or the fourth electrode, on the other hand, a potential difference having a value proportional to said shear stress.

9. The mechanical-stress sensor according to claim 1, comprising at least one fifth electrode and one sixth electrode, each having a plurality of portions or fingers that extend at the first and second major faces, respectively, of the first layer of piezoelectric material, where in particular the portions or fingers of the fifth electrode are interdigitated or alternating with the portions or fingers of the first and third electrodes and the portions or fingers of the sixth electrode are interdigitated or alternating with the portions or fingers of the second and fourth electrodes.

10. The mechanical-stress sensor according to claim 9, wherein:
the portions or fingers of the first, third and fifth electrodes extend at least in the longitudinal direction substantially at a first distance from one another, the portions or fingers of the first electrode, respectively the portions or fingers of the third electrode and the portions or fingers of the fifth electrode, being at a mutual distance which is substantially not less than three times the first distance,
the portions or fingers of the second, fourth and sixth electrodes extends at least in the longitudinal direction substantially at the first distance from one another, the portions or fingers of the second electrode, respectively the portions or fingers of the fourth electrode and the portions or fingers of the sixth electrode, being at a mutual distance which is substantially not less than three times the first distance.

11. The mechanical-stress sensor according to claim 10, wherein the first, third and fifth electrodes, or the respective said portions or fingers, are electrically insulated from one another, and the second, fourth and sixth electrodes, or the respective said portions or fingers, are electrically insulated from one another and from the first, third and fifth electrodes, in such a way that a shear stress applied to the first layer of piezoelectric material in a direction transverse to the longitudinal direction generates between the first electrode and the second electrode, or else between the second electrode and the fourth electrode, or else between the fifth electrode and the sixth electrode, a potential difference having a value proportional to said shear stress.

12. The mechanical-stress sensor according to claim 1, wherein moreover associated to the supporting structure is a second piezoelectric transducer, which is able to generate a second electrical signal representing a normal stress, wherein the second piezoelectric transducer comprises a second layer of piezoelectric material set between two respective electrodes, the second layer of piezoelectric material having at least one polarization axis that extends in a direction transverse to a plane identified by the second layer of piezoelectric material.

13. The mechanical-stress sensor according to claim 12, wherein the supporting structure comprises a substrate, associated to which are the first piezoelectric transducer and the second piezoelectric transducer.

14. The mechanical-stress sensor according to claim 1, wherein at least the first piezoelectric transducer comprises a deposited layer of piezoelectric material and/or deposited electrodes of electrically conductive material at two opposite major faces of the deposited layer of piezoelectric material.

15. A method for fabricating a mechanical-stress sensor according to claim 1, comprising the steps of:
i) forming the first piezoelectric transducer, with the first electrode and the at least one third electrode, or the respective said portions or fingers, at least in part at the first major face of the first layer of piezoelectric material, and with the second electrode and the at least one fourth electrode, or the respective said portions or fingers, at least in part at the second major face of the first layer of piezoelectric material;
ii) carrying out a polarization of the first layer of piezoelectric material, by applying a potential difference between:
at least one of the first electrode and the at least one third electrode, or the respective said portions or fingers, on the one hand, and
at least one of the second electrode and the at least one fourth electrode, or the respective said portions or fingers, on the other hand,
wherein step ii) is executed with a first configuration of electrical connection of the electrodes, or of the respective said portions or fingers, which differs from a second configuration of electrical connection of the electrodes, or of the respective said portions or fingers, which is employed when the first piezoelectric transducer is subsequently used for detecting a shear stress.

16. The method according to claim 15, wherein:
in the course of step ii), the first and second electrodes are electrically connected together-H, and the third and fourth electrodes are electrically connected together and electrically insulated from the first and second electrodes, the potential difference being applied between the first and third electrodes, on the one hand, and the second and fourth electrodes, on the other hand; or else
in the course of step ii), the first, second, third and fourth electrodes are electrically insulated from one another, and the potential difference is applied between one of the first and third electrodes, on the one hand, and one of the second and fourth electrodes, on the other hand, the one of the second and fourth electrodes being the electrode whose said portions or fingers are in a position staggered with respect to said portions or fingers of the one of the first and third electrodes; or else
in the course of step ii):
the electrodes of a first pair of electrodes selected from among the first and second electrodes, the third and fourth electrodes and fifth and sixth electrodes are electrically insulated from one another and from the other electrodes;
the electrodes of a second pair of electrodes selected from among the first and second electrodes, the third and fourth electrodes and the fifth and sixth electrodes are electrically connected together and electrically insulated from the other electrodes;
the electrodes of a third pair of electrodes selected from among the first and second electrodes, the third and fourth electrodes and the fifth and sixth electrodes are electrically connected together and electrically insulated from the other electrodes; and
the potential difference is applied between the second pair of electrodes, on the one hand, and the third pair of electrodes, on the other hand.

17. The method according to claim 15, wherein the first piezoelectric transducer, or the corresponding first layer of piezoelectric material and/or the electrodes at the opposite major faces thereof, is obtained at least in part via deposition of layers of different materials on top of one another, in particular via screen printing.

18. (canceled)

19. The mechanical-stress sensor according to claim 4, wherein each portion or finger of the first electrode is in a position substantially overlying or aligned to a respective one said portion or finger of the third electrode, and each portion or finger of the third electrode is in a position substantially overlying or aligned to a respective one said portion or finger of the fourth electrode.

20. The mechanical-stress sensor according to claim 13, wherein the first piezoelectric transducer and the second piezoelectric transducer are associated to one and the same major face of the substrate.

21. The mechanical-stress sensor according to claim 10, wherein each said portion or finger of the first electrode, respectively each said portion or finger of the third electrode and each said portion or finger of the fifth electrode, is in a position substantially above, or aligned with, a corresponding one said portion or finger of the second electrode, respectively a corresponding one said portion or finger of the fourth electrode and a corresponding one said portion or finger of the sixth electrode.
